(19) United States
(12) Patent Application Publication
(10) Pub. No.: US 2010/0228602 A1
(43) Pub. Date: Sep. 9, 2010

(54) Event information tracking and communication tool

(76) Inventors: Michael Gilvar, Gunter, TX (US); David Hess, Dallas, TX (US); Richard Weldon, Addison, TX (US)

Correspondence Address: George R. Schultz;Schultz & Associates, P.C., One Lincoln Center, 5400 LBJ Freeway, Suite 1200, Dallas, TX, 75240, US

(21) Appl. No.: 12/660,507

(22) Filed: Feb. 25, 2010

Related U.S. Application Data
(63) Continuation-in-part of application No. 12/384,940, filed on Apr. 9, 2009.
(60) Provisional application No. 61/208,627, filed on Feb. 25, 2009.

(51) Int. Cl. G06Q 30/00; G06Q 10/00; G06Q 50/00; H04Q 5/22; G06F 17/24

(52) U.S. Cl. 705/10; 705/14.5; 340/10.1; 715/256

(57) ABSTRACT

A central server system communicates with a plurality of communication devices known as RTLS tags worn by participants of an event in a facility. The RTLS tags communicate with a network located in the vicinity of the facility to determine the position of the RTLS tags in real time. The network transfers information to and from a RTIMS server. Information about identities of the participants, the location of the participants and geographical maps of display booths and exhibitor signage at the event are stored on the RTIMS server in a data store. Reciprocity between participants and exhibitors may be established. The data store may be queried to provide participants information relevant for navigation, lead capture, participant surveys and participant traffic flow. Participant locations may be correlated to entity locations or other participants by the RTIMS system to provide location oriented services. There is a data generation plan for the event design.

### CROSS REFERENCE TO RELATED APPLICATIONS

This application is a continuation-in-part application claiming priority benefit from U.S. patent application Ser. No. 12/384,940 filed on Apr. 9, 2009, U.S. Provisional Patent Application No. 61/206,582, filed on Feb. 2, 2009 and U.S. Provisional Patent Application No. 61/208,627 filed on Feb. 25, 2009.

### TECHNICAL FIELD OF THE INVENTION

This invention relates to a system and method for gathering information during an event, tracking and organizing event information including positional location of people and entities, creating a set of tools for allowing the people and entities to establish actionable relationships with other people and entities.

### BACKGROUND OF THE INVENTION

Business and technical conferences and trade show events have become an important means of developing meaningful and profitable business relationships. Such conferences and events may be classified under a larger umbrella of business activities including but not limited to meetings, incentives, conferences and exhibitions (MICE) events. MICE events can be quite large, drawing tens of thousands of attendees, exhibitors, sales people and organizers all of whom have an interest in maximizing their return on investment related to the event. The attendee, paying to attend, desires to find solutions to business or technical problems and is interested in meeting with as many vendors and other attendees or obtaining as much information as possible during the event that correlate to his or her desires. The exhibitor, paying for booth space and/or signage as well as investing in bringing a number of sales people to the event, desires to collect as many customers as possible through sales lead generation and through developing personal relationships. The exhibitor is interested in maximizing the time that his/her sales force spends in contact with sales leads and the development of new business relationships. The meeting organizer, investing in the MICE event infrastructure and marketing efforts, desires to attract as many attendees and exhibitors as possible on a year over year basis, and in so doing desires that new and meaningful event experiences are available to attract attendees and that the opportunities for relationship development are maximized so that the attendees and exhibitors have received value added services.

The creation of actionable experiences for the attendee and exhibitor are enhanced through efficient data collection and accurate measurement of activity at pre-event, during-event and post-event stages of the MICE event. It is essential, therefore, to have a reliable and efficient system for collecting event data at these different stages and particularly during the during-event stage to accurately record, measure and report event data. An example of a during-event data collection is to count the number of attendees per unit time showing interest in a particular product display at a particular exhibit booth.

The creation of actionable experiences for the attendee and exhibitor are enhanced through new means of communicating information to and from one another. In the case of the exhibitor to the attendee, there is a need to deliver product information which may be vast and complex and a need to present the best sales person matched to the attendee, both in a timely way to capture the opportunity; in the case of the attendee to the exhibitor, there is a need for a means for physically locating those exhibitors near attendees that have the best opportunity to solve those attendees problems and there is a need for a means to communicate to those exhibitors the level of attendee interest in a range of products with expressed desire to know gain more information and; in the case of attendee to attendee, there is a need for a means to exchange contact information and a means to physically locate each other efficiently in a large event hall where cell phone usage is often limited. It is optimal for MICE event situations, therefore, to have a reliable and effective means of communication between all entities.

The communication means and data collection means will optimally coordinate with physical location information to perform real-time event monitoring. The goal of the present invention is to combine traditional data collection and communication means with new physical location technology to create new types of experiences and new types of actionable data. It is one important goal of the present invention that the physical location technology is capable to pinpoint the position of an entity or person to an area consistent with that of a person's combined footprint or less, thereby enabling the data collection systems to place the entity or person in contact with one another. For example, a locating system should be capable of locating a person standing in front of a particular product display in a 50′×50′ booth area that contains a plurality of product displays. The locating system should also be able to resolve a difference between two or more persons standing in proximity to one another in real time.

There are means available in the art to measure positions of devices or entities as a function of time. Accepted standards, for example ISO/IEC 19762-5, now exist.

One class of available technologies for an RTLS system is active RFID (Radio frequency identification) and Active RFID-IR. Active RFID provides only presence information within a monitored area and requires an impractical amount of equipment to monitor the entire event space of a typical MICE event.

Another class of available technology for an RTLS system is optical or IR locating. While meeting the positional accuracy requirements of the present invention, line of site type positioning requires sophisticated tracking mechanisms for just one entity and would be overcome by the need to simultaneously monitor a moving set of several thousand entities.

Yet another class of available technologies for an RTLS system is ultrasound ranging and ultrasound identification (USID). However, the number of entities interacting would be limited in a given area due to bandwidth constraints related to reducing the noise between potentially interacting entities. Also the range distances and accuracy would be very limited.

Wireless LAN technologies, for example Wi-Fi with RSSI capability is a possible technology. But these technologies are limited in positional accuracy as is true of cell phone enabled GPS systems.

Di Floriano, International Patent Application WO 2006/013587, describes a system including a plurality of sensors in a targeted area accommodated by a plurality of people carrying RFID devices. Di Floriano lacks the means or necessary systems to precisely track location, having only the ability to ascertain if a person carrying an RFID device is inside the targeted area. The RFID device is not interactive, thereby limiting the carrier to use a cell phone to communicate desires to the system. Di Floriano does not describe a means of utilizing location information to project advertising or for determining actively controlled immersive media in the targeted area.

Werb in US. Patent Application 2003/0013146 discloses a real-time locating system (RTLS) using a hybrid tag device having a location position system (LPS) transmitter and a beacon transmitter comprising a baseline tag datagram. Kovesdi, et al. in US Patent Application 2003/0155413 provides a description of a system and method for the authoring and providing of information relevant to a physical world. Koveski, et al., however, does not attempt to describe a system for dynamically binding a user to other relevant users with interest in communicating to the user prior to, during or after the playback event. Reacting to and creating a dynamic configuration of users and their profiles are not described.

Valentine, et al, US Patent Application 2008/0312946 propose location based services including real-time tracking and information management for trade show events. Valentine, et al. do not, however, indicate a system scope capable of enabling immersive media experiences such as lighting control or programmatic control of event media systems based on the presence of attendees and their profiles. Valentine, et al. do not describe a set of methods for determining the quality of location of a given attendee or of the system in general, for example, having the capability to map areas within the event facility that has poor ability to determine of location or having the capability to describe the probability of location based on motion vectors.

Valentine, et al. do not disclose a specific system or process for deploying location based services for trade show events, the deployment problem being significantly complicated by the need in the industry to set up an event with short notice between final configuration of exhibitors and show start—sometimes as short as one week. The system implementation aspects are a challenging problem because of the large amount of data being received by the RTLS system and the large amount of data generated by the event. The problem requires tools for rapid processing and manipulation. Various embodiments will be described that address the need for real-time information management system for MICE events, alleviating the need for expensive database analysts and allowing for rapid turn around of post show data assets. Other embodiments describe methods for determining and utilizing a quality of location measure to greatly improve the reliability of real-time association of geospatial zones with RTLS tag devices. Immersive media experiences and location based control systems may also be integrated together to provide attendee and geospatial zone coordination.

### SUMMARY OF INVENTION

The preferred embodiment utilizes an ultra wide band radio frequency (UWB RF) real-time location system (RTLS) system or other technology RTLS in combination with a real-time information management server (RTIMS), database servers, a web based portal application server and a web based dashboard application server together programmed to store, manipulate and control data at the direction of MICE event participants including attendees, exhibitors, sales staff and organizers.

The RTLS/RTIMS system continuously locates each participant through the use of an active RTLS tag which may be placed in the participants badge and verified during a registration process. The location system logs the participant locations in a database for real-time retrievable position and the creation of actions during and after the MICE event.

In one aspect the quality of location is assessed continuously and may be mapped to ascertain the positional accuracy of any participant. Additionally, the quality of location service may be utilized to ascertain the signal strength, coverage and overall health of the RTLS system.

Within the web based portal application, each attendee will be able to specify and control what contact information is provided to each exhibitor that is granted access to the attendee's contact information. Sales staff are provided access to the leads assigned to them by the exhibitor. The web portal access can include browsing, analyzing and exporting of the lead data.

In another aspect, exhibitors will be provided access to an exhibitor dashboard application in order to see live information concerning RTIMS activity related to them. This includes a map component that shows live positions and movements of attendees and sales staff in addition to reporting significant metrics.

The RTIMS of one embodiment can interact with CPUs connected to displays, lighting controls and other environmental devices in order to deliver immersive media experiences to Attendees.

Show organizers, session speakers and exhibitors can survey attendees in real time using the RTLS/RTIMS systems in order to collect more actionable data.

In another embodiment, a directional portal locating system may be constructed with a set of activator devices, wherein the activator devices are capable of detecting and reporting the proximity of an RTLS tag device. Attendees' locations are logged into a trace report, which is further used to create an activity report suitable for use by exhibitors or show organizers after the event.

The concept of delivering relevant value to attendees that interact with an RTIMS system in implicit exchange for attendee data capture and measurements during the MICE event is characterized as reciprocity. A reciprocity also exists for the MICE event organizer. A useful tool for delivering adequate reciprocity and for organizing the equipment, networking and computational needs for a MICE event is a data generation plan.

In a further aspect of the present invention, a data generation plan is consolidated from a data collection strategy and a set of components into a comprehensive event design. In an event design process, a MICE event is analyzed in to maximize reciprocity and define a data collection strategy. The data collection strategy incorporates the goals of reciprocity for the event in terms of generating and capturing relevant data for the MICE organizer and in terms of delivering targeted and personalized information and services to the attendee. The data collection strategy looks at all aspects of the flow of data to and from the various types of entities involved in the MICE event that have potential to create or receive value, for example, the MICE organizer, the attendee, the exhibitor, the exhibitor sales staff, the technical speaker, the local event vendor and the event facilities owner.

Location metric types are defined with respect to a measurement point and an object location, the measurement point being the position of a location measuring device in a predefined MICE event space wherein the measurement point is at a fixed set of coordinates, generally defined in three dimensions and referenced to a predefined origin of coordinates in the MICE event space. The object location is the metric reported by the locating technology during a location event. The location event may be triggered by a change in the object's location. Location metric types for an object are preferably position, proximity, and vicinity and area types.

### BRIEF DESCRIPTION OF DRAWINGS

The description will be aided by reference to the accompanying drawings, which are incorporated in the specification by reference, wherein:

FIG. 1 is a diagram depicting a typical MICE event situation including exhibitor booths and depicting movement and position location of the attendees and sales staff.

FIG. 2A shows an expanded view of a preferred embodiment cellular structure of the RTLS sensor system.

FIG. 2B shows an expanded view of the sensor configuration in a preferred embodiment cellular structure.

FIG. 3 is a block diagram of an attendee or sales staff wearing the RTLS tag and having a cell phone in a preferred embodiment.

FIG. 4 is a block diagram of the RTLS system of a preferred embodiment.

FIG. 5 is a block diagram of a preferred embodiment combination RTLS/RTIMS system functional arrangement.

FIG. 6 is a block diagram of the preferred embodiment RTIMS system network configuration showing the interactions between various entities involved in a MICE event.

FIG. 7 is a block diagram of the RTIMS portal application functions.

FIG. 8 is a block diagram of the relationships of MICE entities of the RTIMS database in relation to the portal application.

FIG. 9 is a block diagram of the relationships of attendee entities and event data entities of the RTIMS database in relation to the portal application of a preferred embodiment.

FIG. 10 shows a screen shot diagram view of the main screen of the dashboard application of a preferred embodiment.

FIG. 11 is a block diagram of the exemplary embodiment of a MICE event information system of a preferred embodiment.

FIG. 12 is a block diagram of the preferred embodiment software architecture of the RTIMS system.

FIG. 13 is a block diagram of the preferred embodiment software architecture of the reporting server.

FIG. 14 is a block diagram of the preferred internal structure including the entity relationships in the reporting server software.

FIG. 15 is a block diagram of the reporting system interactions in the exemplary embodiment.

FIG. 16A is a block diagram of the viewer application program of a preferred embodiment showing views and relational operations.

FIG. 16B is a use case diagram of the viewer application program of a preferred embodiment.

FIGS. 17A, 17B and 17C are screenshot diagrams showing the operations of the viewer application program of a preferred embodiment.

FIG. 18 is a flowchart diagram of a preferred process to determine and report quality of location in a preferred embodiment.

FIG. 19 is a flowchart diagram of the preferred method system setup process for the MICE event information system.

FIG. 20 is a flowchart diagram of a preferred method of RTIMS servicing of attendee requests for information in a preferred embodiment.

FIGS. 21A, 21B and 21C are flowchart diagrams of a preferred navigation program of the portal application of a preferred embodiment wherein the portal application is accessed prior to the MICE event, during the MICE event, and after the MICE event, respectively.

FIGS. 22A and 22B are flowchart diagrams of preferred attendee networking programs of the portal application of a preferred embodiment wherein the portal application is accessed prior to the MICE event FIG. 23 is a flowchart diagram of a preferred attendee networking program to physically locate an attendee during the MICE event.

FIG. 24 is a block diagram showing the preferred functions of the exhibitor advertising portal application.

FIG. 25 is a flowchart diagram of a preferred lead capture program of a preferred embodiment.

FIG. 26 is a flowchart diagram depicting a preferred alerts messaging process implemented by the RTIMS for exhibitor use at a MICE event.

FIG. 27 is a flowchart diagram of a preferred embodiment organizer survey process implemented by the RTIMS of a preferred embodiment.

FIG. 28 is a perspective view of a badge, badge holder and RTLS tag suitable for use in the preferred embodiment of a preferred embodiment.

FIG. 29 is a block diagram showing an example instantiation of the RTIMS system objects for a mood appliance application.

FIG. 30 is a flow chart of a process to consolidate a data collection strategy and an event design into a data generation plan for a MICE event.

FIG. 31 is a diagram depicting the various location metric types for determining the location awareness factor.

FIG. 32A is a block diagram depicting the automated reporting system of the present invention.

FIG. 32B is a flow chart diagram depicting the automated reporting methods of the present invention.

FIG. 33A is a block diagram of a directional portal locating system.

FIG. 33B is a diagrammatic example of a directional portal locating system application showing activators placed in various locations of a building.

FIG. 34 is a state diagram for the example directional portal locating system.

FIG. 35 is a diagrammatic example of a directional portal locating system showing an exemplary trajectory of a tag device moving through a building.

FIG. 36 is a table showing an example activator report for a tag device.

FIG. 37 us a table showing an example trace report for a tag device.

FIG. 38 is a table showing an example activity report for a tag device.

FIG. 39A is a flow chart of a method to operate the directional portal locating system to create activator reports, trace reports and activity reports.

FIG. 39B is a flow chart of a method to update the trace report.

FIG. 40 is a tabular view of the directional portal system states used to evaluate actions associated to the movement of a tag device through a building.

### DETAILED DESCRIPTION

Various embodiments may be implemented in a variety of embodiments in differing event application environments incorporating hardware platforms suitable to the environment. Examples of event application environments are meetings, incentives, conferences and exhibitions hereafter referred to as MICE events. A purpose of the present invention is to deliver and capture marketing information to and from attendees at a MICE event using a real-time locating system (RTLS) in combination with a hand-held tracking device and a set of communication tools.

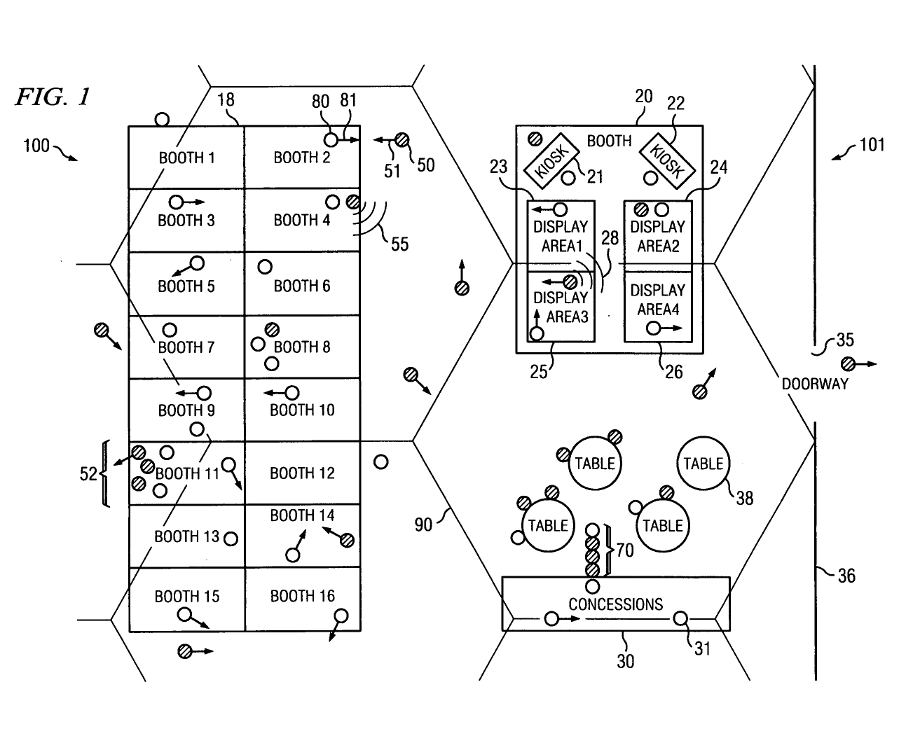

The contextual MICE event is a conference exhibit event, of which a representative physical layout is shown in FIG. 1. The conference exhibit is enclosed in an exhibit hall 100 having at least one doorway 35 in the walls 36 leading to an exterior area 101. Various exhibits, marketing booths, common areas, and concession areas are established in the exhibit hall 100. For example, booth 1, booth 2, . . . , booth 16 form an array of marketing booth areas 18 in which products and marketing materials are presented to exhibit attendees (represented by black circles in the diagram). Each booth is typically occupied by at least one sales person (represented by white circles in the diagram). As an example, booth 2 has sales person 80 moving towards attendee 50. The movement of sales person 80 is indicated by velocity vector 81 and the movement of attendee 50 is indicated by velocity vector 51. In FIG. 1, sales persons and attendees are scattered about the exhibit hall each having their movements indicated by velocity vectors. If there is no velocity vector, then the sales person or attendee is stationary.

Booths may have internal structures. For example, booth 20 includes a first kiosk 21, a second kiosk 22, a first display area 23, a second display area 24, a third display area 25 and a fourth display area 26. The kiosks and display areas are marketing environments designed to attract attendee attention and may form known physical locations in which known product marketing materials are associated. Sales persons and attendees will naturally tend to interact at the known physical locations, especially where the attendee has specific interest in a product. A group of attendees and sales persons 52 are interacting at booth 11 indicating heightened interest in the product marketing materials in booth 11. The association of the location of attendees to the location of known product marketing materials and known sales persons is a key aspect of the present invention. The association process may be enhanced in various ways to create marketing value for the exhibitors; for example, in the preferred embodiment of the present invention, attendees may create a signal, such as signal 28 or signal 55 indicating specific interest in the product associated to the location of the attendee, these signals being processed by the system to allow for targeted follow up by exhibitors.

Exhibit hall 100 may have concession areas such as concession area 30 having associated sales persons 31, a line of attendees 70 and a set of tables 38 in which attendees and sales persons may congregate.

Authorized attendees and sales persons may move into and out of doorway 35 to access exterior area 101.

It is one objective to track the location and movement of the attendees and sales persons in real time, to associate the attendees and sales persons to a booth area or to a product marketing location within a booth area such as a kiosk or display area, to associate attendees and sales persons in proximity to one another, to collect information through a set of signaling mechanisms regarding interactions between attendees and sales persons in proximity and between attendees and exhibitor product marketing materials in proximity, and to create real time information for the event organizers.

An example is to contact the event organizer if the line of attendees 70 at concession area 30 becomes too long, thereby signaling that concession area needs additional sales persons 31 or other resources. Products and supplies in the concession area may be labeled with RFID tags detectable by RFID sensors networked into the RTLS system, so that the RTLS/RTIMS system may track concession inventory.

The embodiments are not limited to collecting real time location, movement and signaling from attendees, but also includes predictive elements. In one example an application is designed to alert a sales person that an attendee with known interest or with known affinity to the sales person's product is physically approaching his/her booth area. In another example, a real time map may be displayed on a hand held device (e.g. cell phone) carried by an attendee so as to guide them to the booths of a specific predefined list of exhibitors. An alternate application may guide the attendee in real-time to booths having products with predefined attributes.

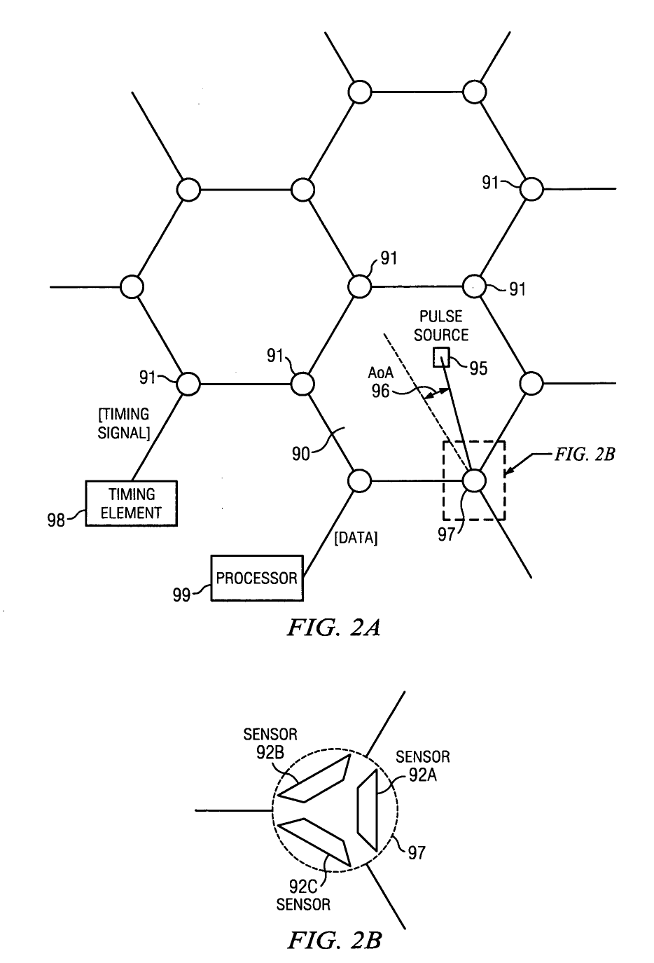

A set of cell areas 90 are superimposed on the exhibit hall 100 and are further explained with the aid of FIGS. 2A and 2B. Cell areas 90 are defined by a set of sensor nodes 91. Each sensor node in the set of sensor nodes 91 contains a plurality of sensors capable of sensing information transmitted from pulsed signal sources and the directionality of pulsed signals generated from the pulsed signal sources. In the preferred embodiment, ultra wide band (UWB) radio frequency (RF) pulses are utilized for the pulsed signals. Other embodiments may use different types of signals such as ultrasound or RF signals such as those used by cellular networks. The sensors are capable of detecting the angle of arrival (AoA) of UWB RF pulses generated from a plurality of UWB pulsed sources.

In FIGS. 2A and 2B, a pulsed source 95 emits UWB RF pulses which are detected by sensor node 97 among other sensor nodes. Sensor node 97 contains an array of sensors: sensor 92A, sensor 92B and sensor 92C. Other sensor nodes are configured in a similar manner to sensor node 97, the other nodes positioned in varying proximity and direction from pulsed source 95. Sensor 92B is capable of measuring the angle of arrival, AoA 96, of the signal from pulsed source 95. Similarly, other sensor nodes may measure their corresponding angles of arrival of the signal from pulsed source 95.

In the preferred embodiment, the sensors contained in the set of sensor nodes 91 are connected together in a network having a central timing element 98 that synchronizes each sensor to one another. The sensors, being synchronized, are capable of detecting pulses and measuring time difference of arrival (TDoA) of pulses across the network of sensors. A central processor 99 may be connected to the network of sensors to collect data from each sensor for processing AoA and TDoA. Central processor 99 is programmed to tri-angulate (more generally poly-angulate) detected positions of pulsed sources, such as pulsed source 95, based on the collected AoA from each sensor in the network of sensors. Central processor 99 may also be programmed to utilize the TDoA data to compute velocity vectors and to compute quality of detected positions. The combination of central processor 99, central timing element 98, the set of sensor nodes 91 and a plurality of pulsed sources similar to pulsed source 95 will be hereafter referred to as a real time location system (RTLS system). The pulsed sources will be hereafter referred to as RTLS tags which generate a continuous stream of UWB RF pulses for ranging. The RTLS tag devices in combination with a separate wireless network are capable of encoding information bits that may pass between the RTLS tags and the RTLS system. The information bits are useful to identify RTLS tags one from another and to transmit real time information generated, for example, by human interfaces to the RTLS tags.

A suitable RTLS system for the preferred embodiment is the Series 7000 RTLS platform from Ubisense Ltd which uses UWB RF pulsed sources and sensors capable of sustaining a continuous 160 Hz update rate, so that a RTLS tag location can be provided every 6.25 ms from each sensor and cell area. The Ubisense system utilizes a 2.4 GHz ISM band wireless network to accomplish communications between the RTLS tags and the system.

While the sensor nodes may be configured in an infinite number of geometrical configurations, the preferred embodiment is to place the sensor nodes such as to form hexagonal shaped cells as in FIG. 2A, with three sensors per node as in FIG. 2B. The typical physical size of sensor cells are approximately 90 feet in diameter and the typical positional resolution of the Ubisense based RTLS is 15 cm in three dimensions. RTLS systems are by their nature cellular. Cell shape and sensor layout is subject to numerous constraints and rules of thumb. In the RTIMS context, a preferred embodiment optimal layout technique is a hexagonal cell design. This design helps eliminate both the presence of dead spots and the efficiency of cell-to-cell hand-off for positional and velocity determination near cell borders.

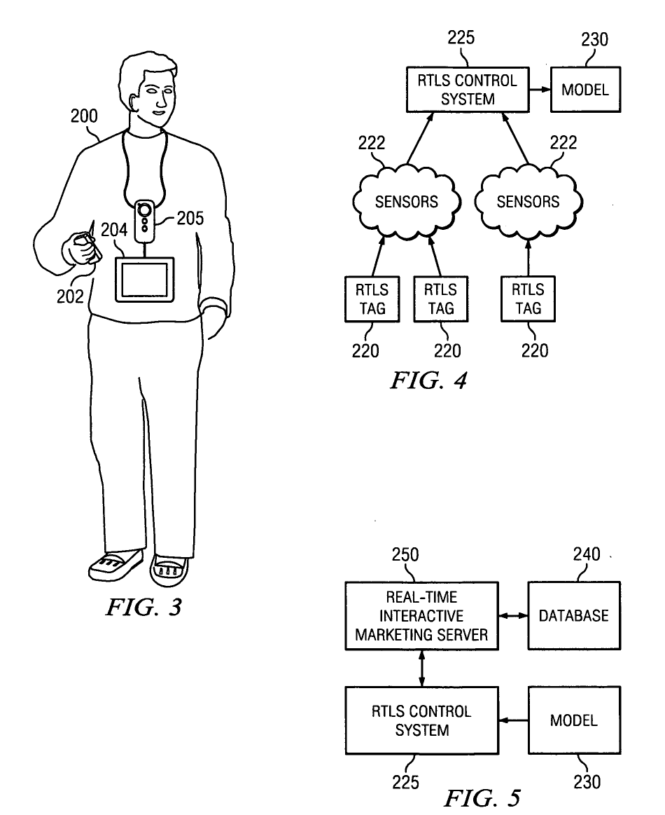

An attendee at a MICE event typically carries a personal cell phone. An RTLS tag is assigned and distributed to this attendee either before the event begins or on-site. Referring to FIG. 3, the attendee 200 carries a RTLS tag 205 and may carry cellular phone 202 with them for the duration of the event.

The RTLS tag 205 is attached to a lanyard or more commonly is contained in a badge holder 204 as shown in FIG. 3 and in perspective in FIG. 28 as in use. In the preferred embodiment, the RTLS tag 205 has features for user interactivity with the RTLS system. A first button 211, a second button 212, a sound generator 213 and at least one LED 214 are integrated into the RTLS tag 205, the buttons allow the attendee to signal the RTLS system, the sound generator 213 and LEDS allowing the RTLS system to signal the attendee. The RTLS tag 205 may also include an integrated motion detector capable of measuring the acceleration of the tag and capable to report changes in motion to the RTLS system. The same functionality RTLS tags may be used for sales staff and other personnel on-site for positional tracking and communication.

RTLS tag 205 is automatically tracked during the MICE event by a network of sensors in the RTLS system as further described in FIG. 4 with reference to FIG. 2A. In FIG. 4, the network of sensors 222 sense RF pulse data from the set of RTLS tags 220 attached to attendees and sales persons registered for the MICE event. The sensors all communicate with an RTLS control system 225 which correlates the tag position and movement information into a continuously updated 3-D model 230 of all RTLS tag positions in the MICE event's physical space (e.g. exhibit hall of FIG. 1). The network of sensors 222 may be either temporarily installed into the MICE event facility for the duration of the event or permanently installed and used for multiple events as they occur in the event facility. The RTLS control system 225 is preferably physically located at the event facility and interconnected to the network of sensors 222 via routed local Ethernet connections between the RTLS control system 225 and individual sensors, the local Ethernet connections typically transporting TCP/IP protocol signals between the RTLS entities. The Ethernet connections may be wired or wireless connections to the network. In the preferred embodiment wired connections are preferred wherein the sensors are powered by power over Ethernet (PoE) cabled connections.

The continuously updated 3-D model 230 of FIG. 4 and of FIG. 5 can be queried by the RTLS control system 225. In FIG. 5, a real-time interactive marketing system (RTIMS) 250 is connected to the RTLS control system 225 allowing for communications and data transfer between them. The RTIMS 250 queries the RTLS control system 225 for positional data in 3D model 230, storing the returned positional data in an internal RTIMS database 240 along with other relevant data stored previously (such as the serial number of the RTLS tag assigned to the attendee, the attendee's cellular phone number and historical positional information previously supplied by the RTLS control system) to generate attendee experiences and to record experience outcomes. Examples of attendee experiences will be given below. RTIMS 250 may be operated as an application in an on-site or off-site server, however, the preferred embodiment has the RTIMS 250 physically located on-site at the event facility and interconnected to the RTLS control system via the local Ethernet network.

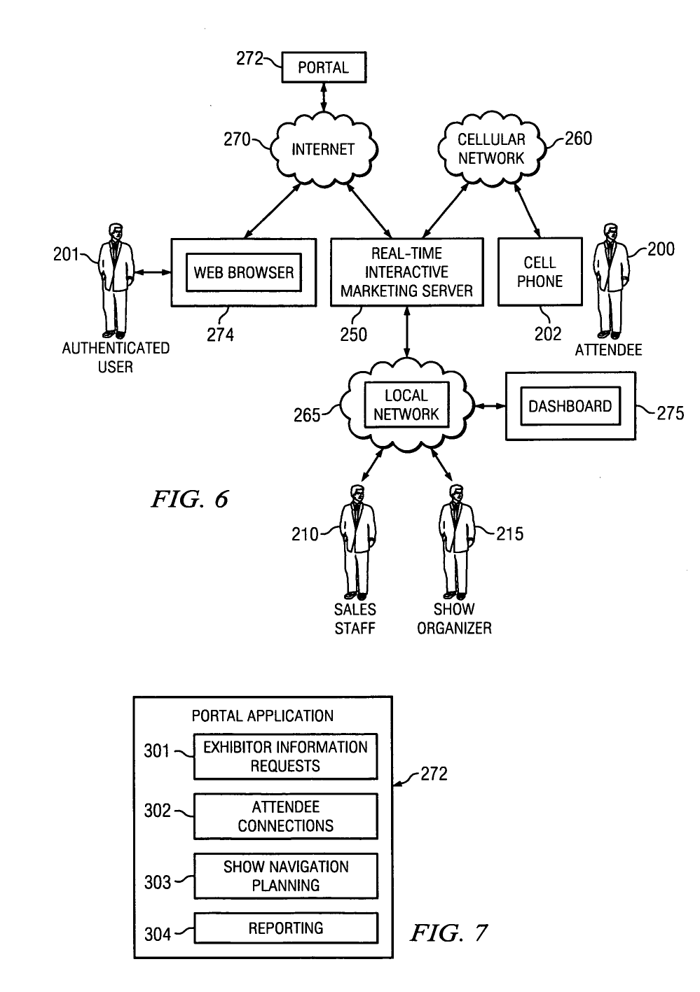

In order to generate experiences for attendees, RTIMS 250 is also interconnected to several networks and serves applications connected thereto. FIG. 6 is a schematic diagram of applications that may be driven by the RTIMS 250. In addition to the local area network 265, the RTIMS 250 may be connected to the internet 270 and to a cellular network 260. The cellular network 260 is used by RTIMS 250 to communicate with attendee 200 via their cellular phone 202, for example, with SMS/MMS messages or through smart phone web browsing functions. RTIMS 250 and attendee 200 are enabled to send unsolicited messages to each other in real-time.

During the MICE event, RTIMS 250 communicates over internet 270 connections to a portal application 272. RTIMS 250 is capable to transfer information collected at and prior to the event, to and from portal application 272 to aid in establishing interactions between and experiences for attendees 200, exhibitors (not shown), sales staff 210 and show organizers 215 of the MICE event.

Before, during and after a MICE event, a set of authenticated users 201 are able to access portal application 272 from a web browser 274 connected to internet 270 for the purposes of configuring and viewing information concerning their experiences and interactions at the event. The set of authenticated users 201 can also all communicate via internet 270 connections or local area network 265 connections to a web-browser based dashboard application 275 that is served from RTIMS 250. Authenticated users 201 are typically the registered attendees, sales staff, exhibitors and organizers but may include other persons or entities having interest in the event.

Portal application 272 is a web application containing programs with at least the functionality to setup, access and manage information related to the MICE event as shown in FIG. 7. Functionality that would be provided to attendees via portal application 272 includes at least a first program 301 providing for the attendee to make and receive exhibitor information requests, a second program 302 providing for the attendee to connect with another attendee, a third program 303 providing for the attendee to plan his/her trip to the event to help the attendee gain maximal information and meet conference objectives, and a fourth program 304 providing for reporting of vital event information back to the attendee.

Per MICE event, the RTIMS database 240 contains information relationally organized as shown in FIG. 8. The show organizer 314 has multiple exhibitors 310 attending their event. Each exhibitor has multiple sales staff 312 attending the event, and all of the show organizers 314, exhibitors 310 and sales staff 312 interact with all of attendees 300.

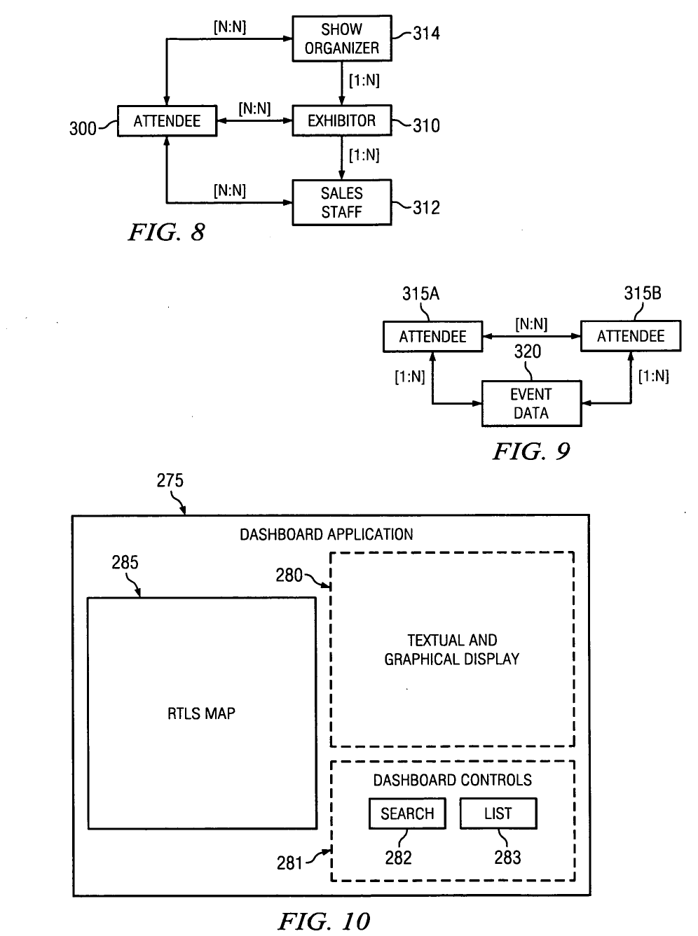

Between events, RTIMS database 240 contains information relationally organized as shown in FIG. 9. Each attendee 315A has relationships to data in multiple events 320 and each attendee 315A can create or accept relational connections between other attendees 315B attending the MICE event.

During the event, attendees, exhibitors, sales staff and show organizers have access to dashboard application 275 which is shown in FIG. 10. Dashboard application 275 provides access to a map component 285, a display area 280 for graphical and textual data and has controls 281 for accessing and controlling RTIMS database information through search functions 282 and list functions 283. Information gathered via controls 281 is displayed using map component 285 or display area 280 or both. The amount and type of data that is available will vary based on the type of person accessing dashboard application 275 and the type of data requested. As an example, an exhibitor may access the dashboard and use its controls to search for attendees from an organization. The search may reveal a graphical display of the attendee locations at the event facility. The search may also reveal a list of attendees meeting the search criteria.

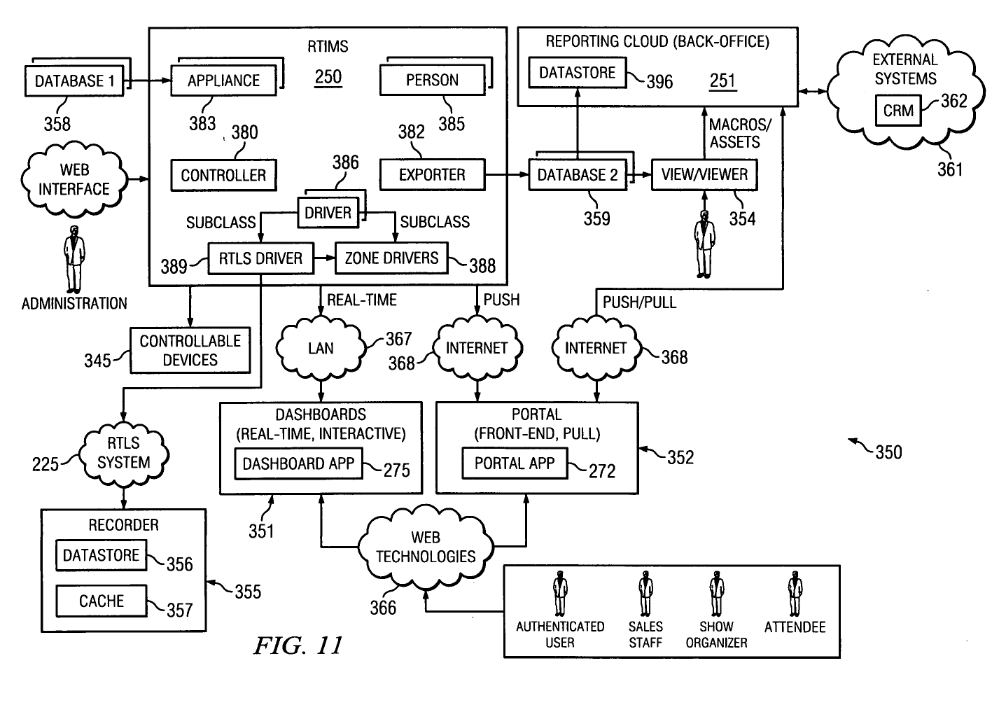

FIG. 11 is a block diagram showing the architecture of an exemplary embodiment MICE event information system 350 comprising the real-time interactive marketing system, RTIMS 250, a reporting system 251, the real-time location system, RTLS control system 225, a dashboard system 351 which operates dashboard application 275, a portal application system 352 which operates portal application 272, a viewer application system 354, a real-time recorder system 355, a first set of database files 358 and a second set of database files 359.

RTIMS 250 is a real-time, multi-processing, asynchronous control system for managing information going to and from the RTLS control system 225, storing and retrieving data about all persons interacting with the system, and coordinating actions between the RTIMS server and client systems including dashboard application system 351, portal application system 352 and a set of controllable devices 345. MICE event information system 350 may comprise multiple server hardware platforms operating in tandem to address multiple processes, applications and user components. MICE event information system 350 has external interfaces to at least the set of external systems 361, a local area network 367 at the event facility and a wide area network 368 which may be the internet. Dashboard system 351 is connected to RTIMS 250 via local area network 367. Portal application system 352 is connected to RTIMS 250 via wide area network 368 and may exist off-site of the event facility. Both the dashboard and portal systems may be accessed by a set of web browsers 366 connected via the internet.

RTIMS 250 is internally architected as multiple processes in a multitasking operating system such as Unix, operating on a modern server hardware platform including at least one processor, having random access memory and having a set of local storage drives.

In one aspect of the invention the set of controllable devices 345 may operate to provide a plurality of electronic environments that are sensitive to and responsive to the presence of humans. The plurality of electronic environments is known as the ambient intelligence associated to the MICE event.

Examples of ambient intelligence with controllable devices are: client hardware stations such as a registration station executing an attendee registration, digital signage displaying real-time changes in messaging, DMX lighting systems executing changes in exhibit hall lighting, sound systems producing announcements and music, and web cameras streaming video and audio marketing productions. Ambient intelligent systems may work in conjunction with the RTLS system to identify a person in proximity to an environment and change the environment, for example, changing a localized announcement to attract the specific calculated interest of an attendee passing by a booth. Ambient intelligence supports immersive media experiences wherein a person interacts with a computer application, for example, and the interaction proceeds in a personalized way that is combined creatively with the person's environment. More examples of ambient intelligence and immersive media will be given below.

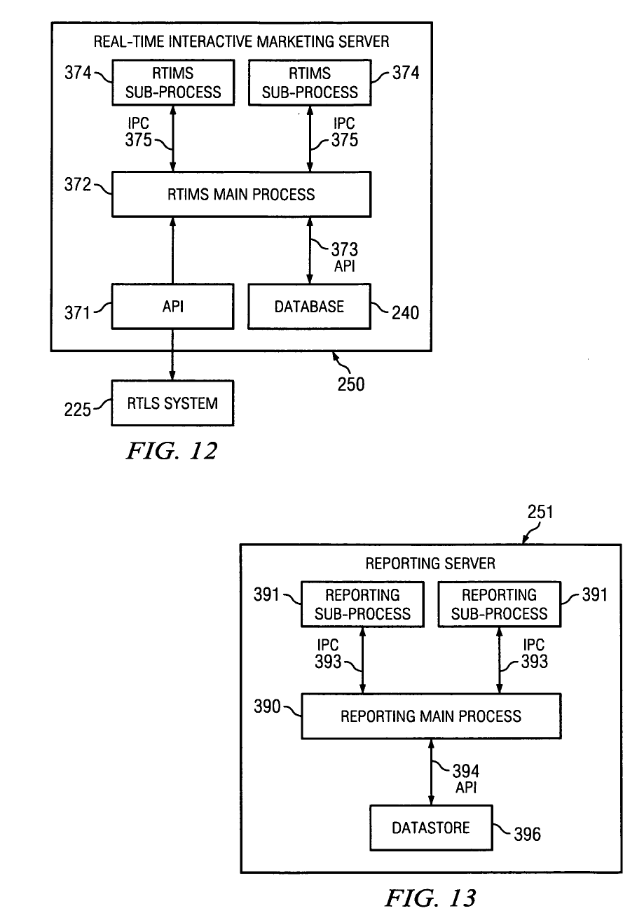

Referring briefly to FIG. 12, RTIMS 250 operates RTIMS main process 372 as an asynchronous, event-driven application. It uses off-the-shelf event application libraries to manage all system activities as events and responses to them. In the exemplary embodiment, RTIMS main process 372 implements a software design that enables the representation of complex system behavior with a simple set of objects. RTIMS main process interacts with an object oriented RTIMS database 240 which utilizes internal database components with an API 373 for storing and retrieving arbitrary data structures. The RTIMS main process 372 is responsible for coordinating all RTIMS related behavior in real-time. It is capable of decomposing its behavior into multiple processes in order to take advantage of multiprocessing hardware. This decomposition is enabled by using an inter-process communication protocol IPC 375 between the main process and a set of sub-processes 374. RTIMS 250 interacts with RTLS system 225 which has a documented RTLS API 371 for receiving real-time notices of RTLS events such as RTLS tag sighting and containment events when an RTLS tag is identified within a specific region of the three dimensional space.

In one aspect of the RTIMS system, all operations between processes and sub processes are asynchronous and non-blocking. The non-blocking aspect alleviates the need to use threads to achieve multiprocessing behaviors within a process which simplifies the software development.

Objects are containers for methods and attributes inherited from object classes and programmed according to standard object oriented programming rules known by those skilled in the art. The invention meets real-time performance and ease of operational set-up by utilizing object oriented internal data structures which are dynamic in nature and are treated like database objects. Object-oriented database management systems (OODBM) suitable for use in the present invention is a known class of databases available as off-the-shelf software components

In an alternate embodiment, RTIMS database 240 may be constructed with an off-the shelf SQL database server with a documented API, although performance and ease of deployment are likely to be deficient compared to the exemplary embodiment.

Referring again to FIG. 11, the processes and fundamental object classes of RTIMS 250 are indicated. RTIMS has controller 380 for creating and managing objects during real-time operation. The relevant object classes for the managed objects are appliances 383, persons 385 and drivers 386. RTLS driver 389 and zone drivers 388 are subclasses of the drivers 386 which are fundamental to the operation of the RTIMS system.

The data structures associated to the objects may be imported from a first set of database files 358 and exported to a second set of database files 359. The second set of database files 359 are considered to be data models capturing the behaviors of attendees, exhibitors, sales staff and organizers prior to and during an event. In the exemplary embodiment both sets of database files are realized as tables written to standard CSV files which are stored on the RTIMS system's local storage drives and which may be written to computer readable media for transmission to other systems. Exporter process 382 is a sub-process for exporting data structures into second set of database files 359. Examples of exported data structures are guests in guests.csv, which are instantiations of persons 385 and zone activity encapsulated therein.

In an alternate embodiment, CSV files may be imported from remote sources over the internet to establish an RTIMS appliance such as an exhibitor display system. The exhibitor display system may be associated to a proximate attendee, the attendee having attributes that allow information to be gathered in real-time from a remote interne resource. The information is gathered and presented to the display system via the RTIMS system in the form of targeted information such as an advertisement, or a targeted survey.

Continuing with FIG. 11, persons 385 are object representations of a real-world person (e.g. an attendee) that is known by the RTIMS, for example, through a registration process wherein the subset of the real-world person's information is stored prior to the event in first set of database files 358. Appliances 383 are objects that represent high-level system behaviors of physical world devices and systems embodied in the RTIMS server. Examples of these appliance behaviors are: digital signage content personalization, lighting control/behavior, attendee registration and dashboard content management. Drivers 386 are objects that represent lower-level system behaviors that may be embodied within the RTIMS server or within the set of controllable devices 345. If the behavior is external, then a subset of drivers 386 implements an interface between an appliance and that external behavior.

RTLS driver 389 is a specific driver object for interfacing to the RTLS system to collect attendee and sales staff positional data.

Zone drivers 388 is a specific set of zone driver objects for holding geospatial coordinates and containment information related to geospatial areas called zones. Zones may be static or dynamic. Each person (holding an RTLS tag device) has a dynamic zone associated to them. An exhibitor booth is an example of a static zone. Zone drivers 388 act upon changes to static zone containment data, and report dynamic zone crossings.

Positional tracking of a set of persons is accomplished as follows. A zone driver object is associated 1:1 to a static zone predefined in the RTLS system for the facility. A person object is associated 1:1 to a dynamic zone assigned to a RTLS tag device worn by one person in the set of persons. A given zone driver object captures and records in its data structure a list of person objects that are currently contained within the given zone driver object's geospatial area. A person object captures and records in its data structure a perpetual list over time of static zones that the associated person has entered including the current static zone where the person is located. The person object also captures and records in its data structure a perpetual list over time of other dynamic zones that have enters the associated person's dynamic zone over time. Predefined parameters may be used by the person objects for defining when a zone entrance occurs including the physical dimension of the dynamic zones and the minimum zone overlap time.

Reporting system 251 of FIG. 11 is a back office system programmed to provide reporting services based on data gathered during a MICE event by RTIMS 250. Reporting system 251 draws data from second set of database files 359 into reporting data store 396 for internal processing. Portal application system 352, viewer application system 354, and external systems 361 may exchange data with reporting system 251. External systems 361 may connect customer relationship management systems (CRM) 362 to reporting system 251 for organizing sales, marketing and other data pertinent to exhibitors, show organizers and customers of data generated during a MICE event.

Reporting system 251 is further explained with the help of FIGS. 13, 14 and 15. In FIG. 13, reporting system 251 comprises a reporting main process 390, a reporting data store 396 and a set of reporting sub-processes 391. Reporting system 251 is internally architected as multiple processes in a multitasking operating system such as Unix operating on a modern server hardware platform including at least one processor, having random access memory and having a set of local storage drives.

Reporting system 251 may comprise multiple server hardware platforms operating in tandem to address multiple processes, applications or users. The reporting data store 396 has functionality similar to the database functionality of the RTIMS system utilizing internal object oriented methods and procedures, defined in API 394, to manipulate tables of data imported from second set of database files 359.

In an alternate embodiment, reporting data store 396 may be an off-the-shelf database server with a documented API for storing and retrieving arbitrary data.

The reporting main process 390 is responsible for coordinating all reporting related behavior. It can decompose its behavior into multiple processes in order to take advantage of multiprocessing hardware, for example, to service multiple simultaneous queries from external systems. This decomposition is enabled by using an inter-process communication protocol, IPC 393, between the reporting main process 390 and the reporting sub-processes 391.

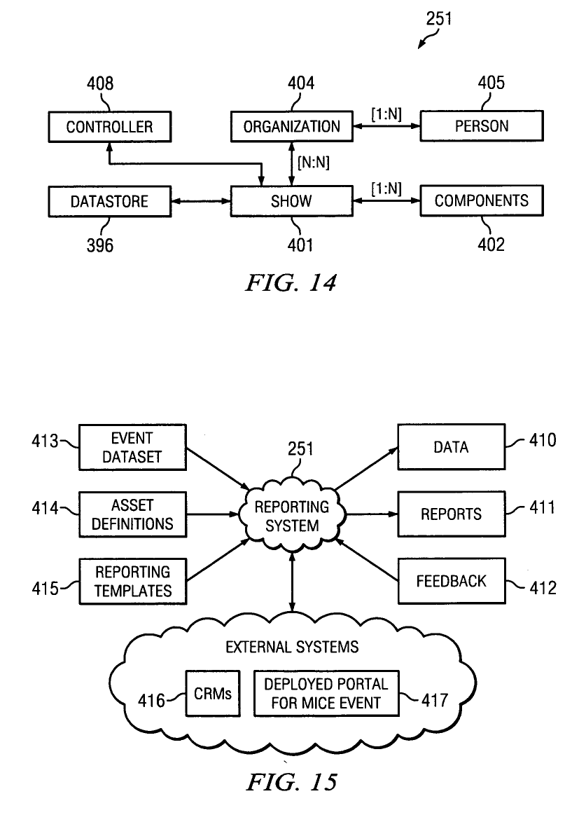

In FIG. 14, the processes and fundamental object classes of reporting system 251 are indicated. Reporting system 251 has controller process 408 for creating and managing objects during operation. The relevant object classes for the managed objects are shows 401, organizations 404, persons 405 and components 402. Shows 401 are constructed from the imported sets of database files (CSV files) via reporting data store 396 and contain information related to multiple MICE events. Components 402 are aspects of given MICE events, for example, the RTLS system configurations for the given MICE events. Organizations 404 may be show organizers, exhibitors and advertisers involved in the plurality of shows 401. The reporting system allows for a plurality of organizations per show and a plurality of shows per organization. Persons 405 are objects representative of people associated to organizations 404.

In FIG. 15, reporting system 251 has functional capability to perform tasks prior to and after the MICE event including obtaining data 410 from the event RTIMS system; generating reports 411, which may be electronic reports or hardcopy reports; collecting feedback 412 from participants; establishing event datasets 413 prior to the event; establishing asset definitions 414 prior to the event which are sets of relational operations for organizing data from the event; utilizing report templates 415 which are document templates, slide presentation templates and similar file templates previously created to generate desired forms for reports; communicating with CRM software 416 in external systems; and interacting with a deployed portal 417 for a given MICE event. The controller process of reporting system 251 processes a report by importing and operating on required event datasets using the set of relational operations in an asset definition then merging the resulting dataset from the relational operations with one or more report templates.

In relation to reporting system 251, portal applications are represented by two concrete and separate functions: a reporting function and user facing function. The reporting function of the portal application interfaces to reporting system 251 for the back office automation of the following tasks:

a. collection and storage of data generated by user facing function,

b. processing and report generation on the data in reporting data store 396,

c. distribution of data to and from external systems and people, and

d. collection of feedback from recipients of distributed data.

The user facing function is a standard web application, such as a user home page, that can communicate with the RTIMS and with the reporting system to provide authenticated user facing functions such as the attendee functions of FIG. 7.

Referring back to FIG. 11 once again, real-time recorder system 355 is a process in a multitasking operating system such as Unix, operating on a modern server hardware platform including at least one processor, having random access memory and having at least one local storage drive in which recorder data store 356 is organized to contain the collected RTLS tag locations.

RTLS control system 225 streams RTLS tag device location coordinates to the RTIMS 250 and to the real-time recorder system 355 as the sensor network senses RTLS tag devices. In the exemplary embodiment, the RTIMS 250, via RTLS driver 389, filters the streamed location coordinates to identify zone crossings only. Real-time recorder system 355 interfaces to RTLS control system 225 and is programmed to collect all streamed RTLS tag locations continuously as they are sensed and identified by RTLS system 225. For example, an RTLS tag may be configured to send out a UWB RF pulse for position location in predefined time slot at a frequency of 1.0 seconds. In the preferred embodiment RTLS system, predefined time slots are organized by a master sensor in the set of sensors making up each cell sensor area and are spaced apart by 6.25 ms in a 160 Hz sampling system.

In one aspect, real-time recorder system 355 may operate a post-show motion picture application wherein the location coordinates of the set of RTLS tag devices, as contained in data store 356, are plotted on a map of the event facility as a function time. A snapshot of recorder data store 356 may be copied to a snapshot file, allowing the motion picture application to operate during the show using the snapshot data. The motion picture application may plot positions and attributes of persons carrying the RTLS tags using symbols and colors to plot unique locations of attendees, sales persons, or sets of persons with similar attributes, the colors and symbols identifying person's attributes. The motion picture application is useful to determine, for example, the movement of sales people of a particular exhibitor during a time period or in a security application, the movement of a person suspected of wrongful behavior at a particular location and time.

In another aspect of the present embodiment, Real-time recorder system 355 is capable of maintaining a location cache 357 for holding the last reported location for each RTLS tag device. Location cache 357 may then be accessed at any time by the RTIMS system to render event maps avoiding the need to poll the RTLS system for current locations. The location cache access method is much more efficient than polling and reloading the data over a network.

Viewer application system 354 of FIG. 11 contains a viewer application program that is used to manipulate CSV files, most importantly the set of database files 359 but not limited thereto. The viewer application program is (1) a quick and efficient tool for the mining of data from several sources to create actionable information assets; and (2) a means to rapidly create reporting templates for reporting system 251. The viewer application system treats data as self-describing tables rather than requiring a process of pre-defining SQL table schema and then importing data into the SQL table schema.

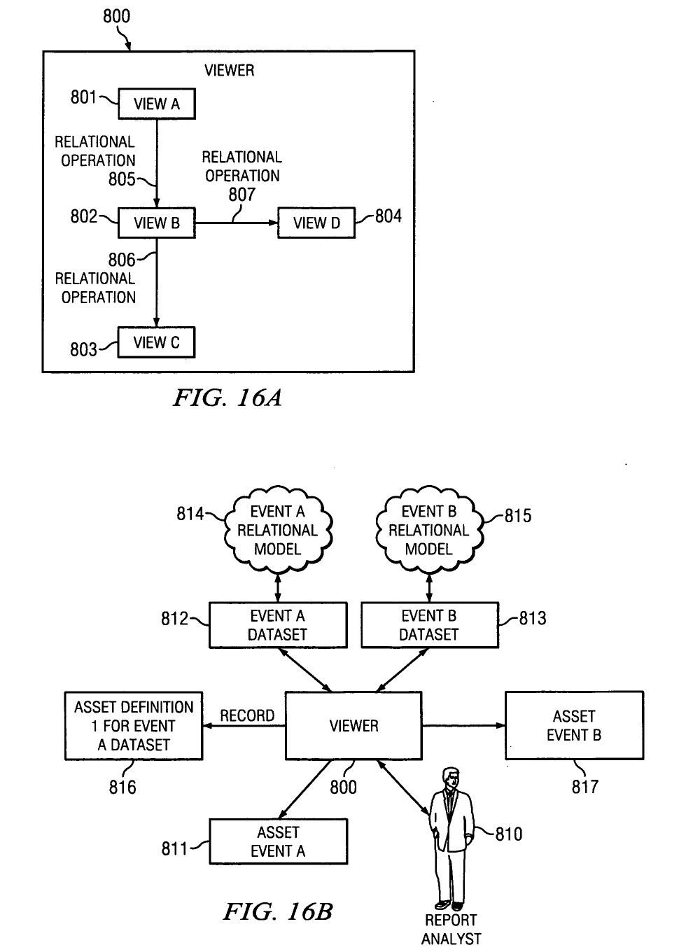

The viewer application program is explained with the help of FIGS. 16A, 16B, 17A, 7B and 17C. Beginning with the example of FIG. 16A, viewer application'program 800 is a desktop computer application programmed to include functionality to allow a user to open one or more CSV files into one or more corresponding table views. Viewer application program 800 is also programmed with a predefined set of relational operations which may operate on the one or more corresponding table views to create new set of table views. The created table views may be saved in local storage devices as new CSV files. The set of relational operations used to create the new set of table views may be recorded as an executable macro and saved.

In operation, the example of FIG. 16A shows that a first table view 801 is opened and a first relational operation 805 is performed to generate a second table view 802. A second relational operation 806 operates on second table view 802 to create a third table view 803. A third relational operation 807 operates on the second table view 802 to create a fourth table view 804. Relational operations are similar to SQL relational operations such as SELECT, JOIN, and PROJECT. The example of FIG. 16A, while a very simple example, illustrates a programming environment wherein a user may interact with any set of CSV files regardless of their content, source or original purpose, i.e. the CSV files may have been built by scanning a website, creating tabular data from a user generated program or similar process and may not necessarily have been created as a part of the RTIMS system or exported from a pre-existing database system. Viewer application program 800 allows for data manipulation in a way that is similar to standard database functionality without requiring the overhead of a database analyst to work under database system constraints and without requiring that the data was properly loaded into a database system.

FIG. 16B shows a use case of viewer application program 800 wherein a report analyst 810 interacts with the viewer application program 800 to create informational assets from distinct MICE events, event A and event B. Event A relational model 814 is built by an RTIMS system and saved in CSV files as Event A dataset 812. At a later time and for a different event, Event B relational model 815 is built by an RTIMS system and saved in CSV files as Event B dataset 813. Event B, for example, may occur a year after Event A. Viewer application program 800 is utilized to manipulate data from Event A dataset 812 by interactively performing a set of relational operations on the Event A table view and table views generated by one or more of the relational operations. The set of relational operations are recorded in asset definition 816 which may be stored as a recorded macro that is executable and capable of begin replayed to recreate the set of relational operations. The output table views after applying the relational operations are stored in Event A informational asset 811 as one or more CSV files. Asset definition 816 is then used to operate on Event B dataset 813 to create a new Event B informational asset 817 without requiring report analyst intervention.

Macros such as asset definition 816 may be merged with report templates in the reporting system to organize data into reports including data from a plurality of events having a plurality of CSV files. Thus, the viewing application program may be used to create client report templates specifically customized for the client that may be run automatically, rapidly and repeatedly by the reporting system as required by the client's CRM or similar systems.

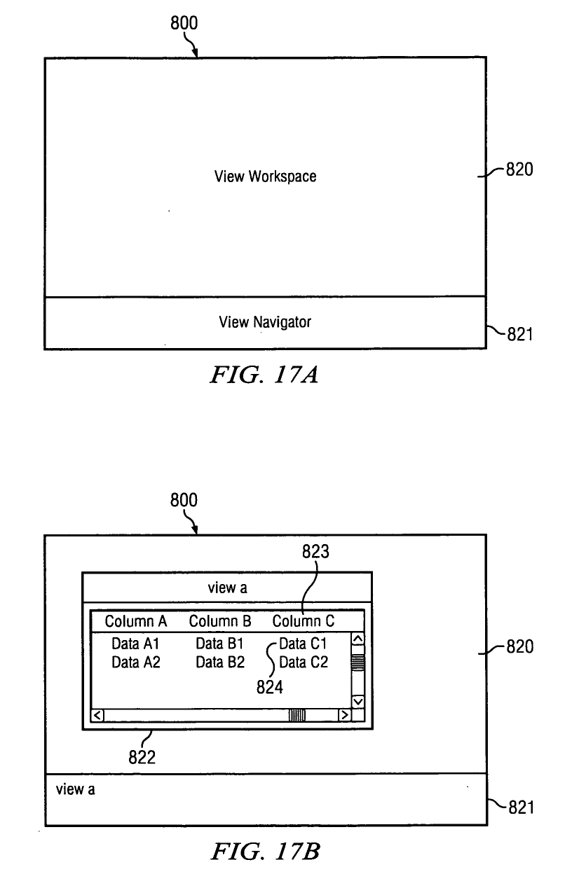

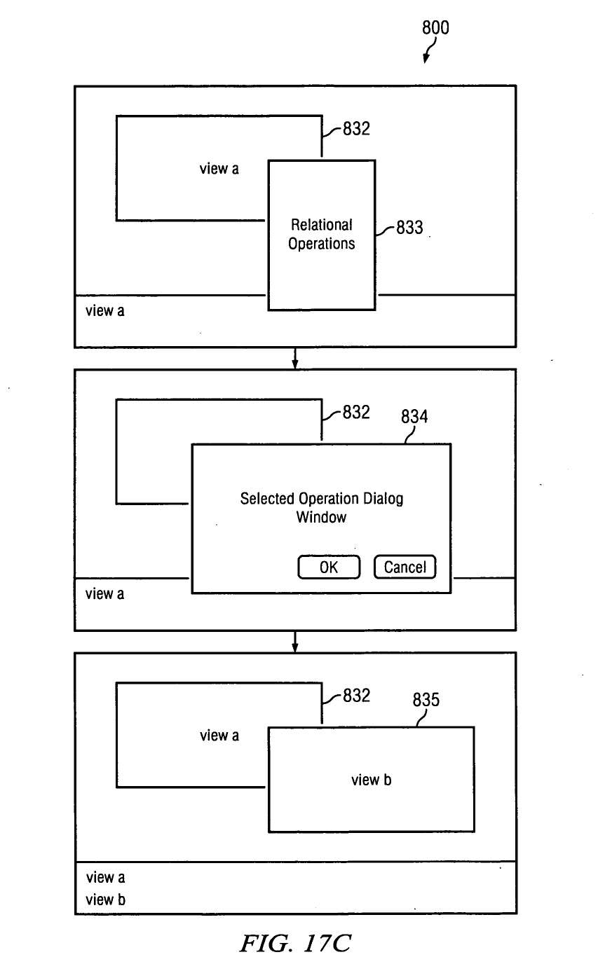

FIGS. 17A, 17B and 17C show screenshot type graphical views of viewer application program 800. Beginning with FIG. 17A, viewer application program 800 has the capability to present a view workspace window 820 and a view navigator window 821. In FIG. 17B, a requested view, “view a” is opened by interaction with view navigator window 821. Viewer application program 800 is programmed to respond to the requested “view a”, by opening a CSV file associated to “view a” and displaying a table view 822 of “view a” organized into columns 823 and rows 824.

FIG. 17C shows three screenshot views of the viewer application program while responding to requests for relational operations. Viewer application program 800 is programmed to present a pull-down list 833 of possible relational operations from which one relational operation may be selected to operate on “view a” 832 which was previously selected in the view navigator window. Viewer application program 800 is programmed to respond to the relational operation selection, first by opening a confirmation dialog 834 and then, based on approval in the confirmation dialog, performing the relational operation on “view a” 832 selection to create a new view, “view b” 835. Viewer application program is programmed to make “view b” 835 available for further operation through the viewer navigation window.

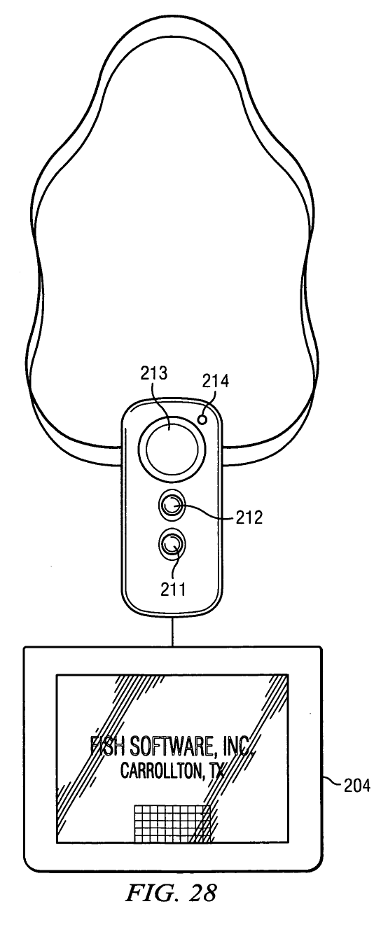

FIG. 29 shows a block diagram of an example event situation showing the set of objects and their interactions in the RTIMS system for the example situation. An RTIMS system 420 is shown with specific instances of objects at the time of the example event. An instance of a person 422 and a particular appliance, mood appliance 421, are defined prior to a locating event in the RTIMS system. The locating event is derived in zone driver 423 having received a zone report from RTLS driver 424 that the person associated to person 422 has just entered the zone associated to zone driver 423 zone and is contained within the associated zone, the RTLS driver 424 having obtained the locating event from the RTLS system 429. In the example of FIG. 29, the zone associated to mood appliance 421 has similar coordinates as the zone associated to person 422, so zone driver 423 captures the fact that mood appliance zone contains person 422 zone and sends a message to mood appliance 421 that person 422 has entered its zone. Mood appliance 421 then queries person 422 for an attribute such as the color preference attribute. Mood appliance 421 then sends a message to DMX driver 425, which controls the settings for lighting in the facility, to adjust the color of lights associated to the location mood appliance 421 to the preferred color of person 422. DMX driver 425 receives the command, processes it, then communicates with a DMX network 426 existing in the facility and connected to a light controller 427. DMX network 426 then passes to light controller 427 the command to change the color at the location of mood appliance 421. Light controller 427 changes the color of the lights 428 in the vicinity of the location. This simple example demonstrates a method that the MICE event system may use to coordinate ambient intelligence to create immersive experiences for attendees of a MICE event.

The successful operation of the MICE event system includes the generation and usage of performance management metrics, the most important of which is Average Quality of Location (AQoL), AQoL is a metric that is defined on a per RTLS tag basis as the average age of each tag's location which is reported to the RTIMS by the RTLS system. This is a running average meaning it is updated regularly as time passes and each time the RTLS system reports a new sighting for the tag. The running average can have a smaller window or a larger window depending on how the AQoL value will be used.

The usage of AQoL includes:
a. As an indicator of the confidence level that the RTIMS system has an accurate real-world concept of where a person is currently located (vs. where the RTLS system last reported them)
b. As an indicator of system performance, the AQoL can be used to produce quality contour maps of the RTLS coverage area. These maps can be used to detect problems with system performance/coverage in particular areas. Prior to the event the quality contour maps may be also be examined to set sensor cell physical dimensions. For example, a 160 Hz system with a global AQoL target of less than 1 second will limit the cell density to 160 RTLS tag devices. If through historical data, an average density of persons within a sensor cell area is projected to be greater than 160 than the physical sensor cell dimensions may be reduced.
c. A tag based AQoL may be used instead of a global AQoL to support events where the average density of persons within many sensor cell areas is projected to be greater than cell density limit of the system. In this type of situation, the RTIMS system dynamically determines AQoL priorities for RTLS tags located within crowded areas. The AQoL priority is determined from metrics that may be based on the persons attributes and the proximate exhibitor attributes. Those RTLS tags with lower priorities may report their positions less frequently, thus allowing a larger number of lower priority tags into the sensor cell area. An added benefit of tag based AQoL is that sensor cell areas may be made larger if the event organizer is willing to allow a set of lower priority tags in the facility which have more uncertainty in their location. Larger cell areas in a given event translate into lower hardware and network costs for the given event.
d. As an indication of system data generation quality, AQoL values aggregated by event can be calculated to indicate the overall quality of data collected during the event in order to provide confidence levels in the context of reporting.

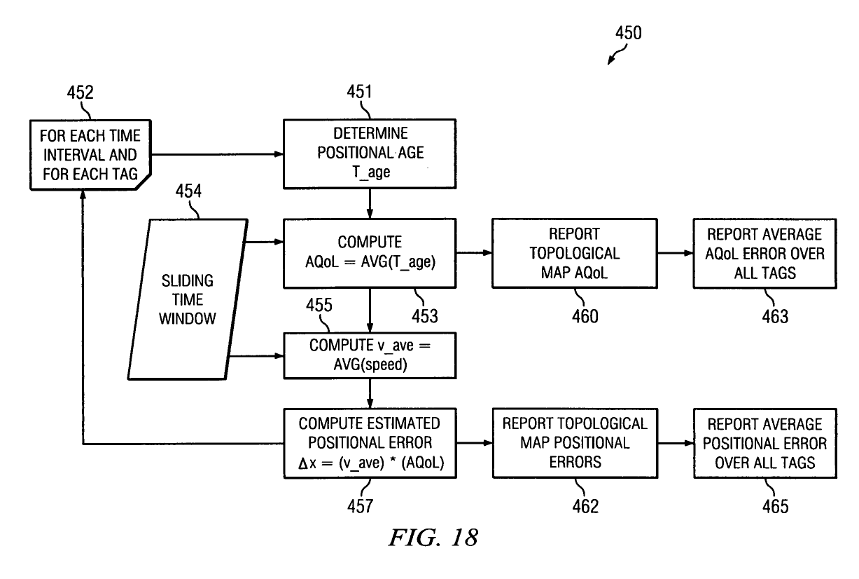

FIG. 18 is a flowchart of a quality monitoring process 450 to generate and utilize AQoL and positional error for the RTLS system. Quality monitoring process 450 is repetitive and begins with the step 451 wherein the RTLS system determines the positional age T_age of a given RTLS tag in a given time interval. The positional age T_age is defined as the time since the last positional update from the RTLS system, wherein RTLS tag position was most recently triangulated and reported. In step 453 the AQoL is computed as a time sliding average of T_age for the given RTLS tag, the width of the sliding time window 454 being pre-defined. Step 455 follows wherein if the position and velocity for the given RTLS tag have been updated since the last time interval, the average speed v_ave is computed as a time sliding average of the updated speed (magnitude of updated velocity) for the given RTLS tag over the width of the sliding time window 454. Once the v_ave and AQoL is determined, a positional error estimate Δx is made in step 457 by multiplying v_ave by AQoL, the positional error effectively estimating the sphere of distance the RTLS tag has potentially moved since the position was last updated.

Steps 451, 453, 455 and 457 are repeated via step 452 for each RTLS tag in a given system time interval and for all tags at regular system time intervals. At certain predetermined system time intervals, reports are created in step 460, step 462, step 463 and step 465. Step 460 reports a topological map of AQoL. Step 462 reports a topological map of positional errors Δx. In step 463, the AQoLs are averaged across all RTLS tags to provide a first aggregate measure of the system quality. In step 465, the positional errors Δx are averaged across all RTLS tags to provide a second aggregate measure of system quality.

The apparatus described herein is flexible to create value for MICE event participants including attendees, exhibitors, sales staff and event organizers. Methods and processes to use the real time marketing system are now described in the context of creating useful tools for the MICE event participants.

The successful deployment of an RTLS system in an RTIMS context involves techniques that reduce the complexity of setup and increase performance. Setup of an RTLS system involves an in-depth surveying and tuning process in order to ensure acceptable operation. The complexity of this process is aided by software tools which assist with the gathering of and organization of surveying information such as: survey points, frame of references, organizing distance measurements, automatically determining sensor locations based on individual related measurements and cross-checking to determine likely causes of error.

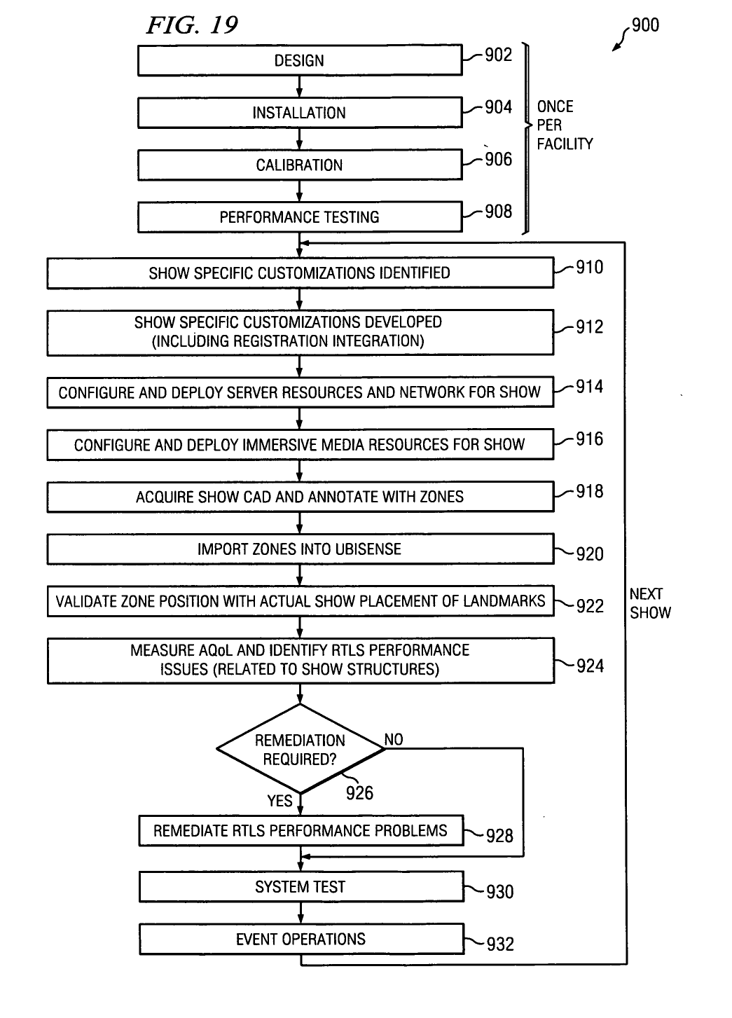

A process to set up operation of the MICE event information system is shown in the flowchart of FIG. 19. The process 900 as described uses the exemplary embodiment MICE event information system of FIG. 11, but may be appropriate for a variety of apparatus embodiments conceivable according to the present invention. The process as shown in FIG. 19 works for multiple facilities and multiple events per facility.

Beginning with the steps related to facility preparation, step 902 begins the process wherein the RTLS system is designed, a design representing the number and configuration of sensors, grouping the sensors into cells and defining the number and configuration of cells, the physical cell size, the wired and wireless RTLS network components and similar features. The RTLS system is then installed in step 904, calibrated in step 906 and then undergoes performance testing in step 908, wherein quality of location, AQoL, is verified to meet predefined levels throughout the facility. Steps 902 through 908 are only necessarily repeated once per facility although step 908 of performance testing may be selectively completed again for selected events. Performance testing is done prior to placement of show structures.

Following the facility preparations, MICE event (show) specific operations begin. In step 910, show specific customizations are identified and in step 912 the identified customizations are developed including necessary software development and configuration. An example of show specific customizations is the integration of registration processes with the MICE event information system. Once the show specific customizations are developed they are ready for site configuration and deployment. In step 914, the server resources are configured and deployed. Examples of server resources are the RTIMS system, a DMZ system, and the RTLS recorder system. In step 916, immersive media resources and systems are configured and deployed. Examples of immersive media are large display video systems, 3D video systems, interactive lighting systems and music systems.

After the show specific resources are configured and deployed, the facility is mapped and static geospatial zones are defined in step 918. The facility may be mapped using CAD designs which may be imported into the RTIMS system, for example, by using CSV files holding tabular information with columns of coordinates and rows associated to distinct zones. The zones may be imported into the RTLS system in step 920 after which the zones are physically validated in step 922 by walking through the facility with one or more RTLS tag devices. AQoL is then checked again in step 924 after the show structures are fully in place and performance issues identified for remediation in step 926. If required, remediation of the RTLS system is performed in step 928, remediation including, for example, movement of RTLS sensors and recalibration of the system. If remediation is complete or not required the RTLS and RTIMS systems are integrated and tested in step 930. The event operation occurs in step 932.

Steps 910 through 932 are repeated per event wherein the facility has been set up previously according to steps 902 through 908.

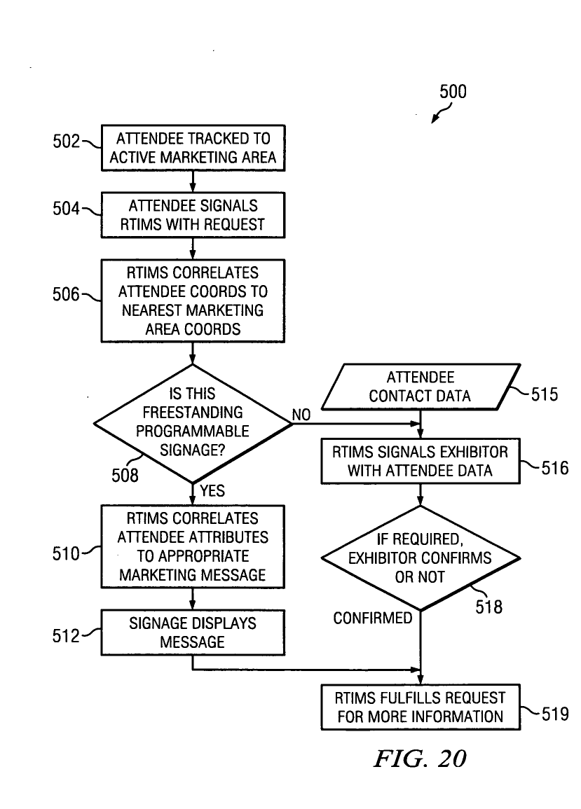

During event operation, the RTIMS functions to automatically record and fulfill attendee requests for product information from a targeted exhibitor. Referring to FIG. 20, information request process 500 is shown. When an attendee is located in an exhibitor's booth, having been tracked to that location by the RTLS/RTIMS system in step 502, the attendee can indicate in step 504 via a button press on the RTLS tag that they desire more product information from the targeted exhibitor. Optionally, the attendee may send a SMS/MMS message from their cell phone. In step 506, the RTIMS server correlates this request with the attendee's current position in order to determine the targeted exhibitor for the request. If the location does not correlate to a freestanding signage location, step 508, the desire for information is routed to the determined exhibitor in step 516 and access is granted to the targeted exhibitor for the attendees contact information 515. In step 519 the request may be fulfilled by any combination of SMS/MMS messaging back to the cell phone, email or other electronic means including posting information to the portal application associated with the RTIMS server. The requests may be automatically fulfilled; optionally, the exhibitor may act as a manual gatekeeper for such product information requests in step 518, receiving product information requests, for example, via the dashboard application.

In addition to booth oriented exhibitor information requests, attendees can approach arbitrary areas with freestanding signage indicating a topic of interest (for example a wall poster, a digital sign having programmable messaging, or simply a marking on the carpet). The attendee can indicate via the RTLS Tag, or alternatively a SMS/MMS message interaction, a generic request for “more information”. After determining that such a freestanding request has been made in step 508, the process continues with step 510, wherein the RTIMS associates the freestanding request with the topic assigned to the location the attendee is standing. The association may include attendee attributes to determine the topic of interest. If the freestanding signage is digital signage with programmable messaging, the digital sign is caused by the RTIMS system to display the topic of interest in step 512. In addition to or in lieu of step 512, the RTIMS may also fulfill the request for “more information” as described in step 519.

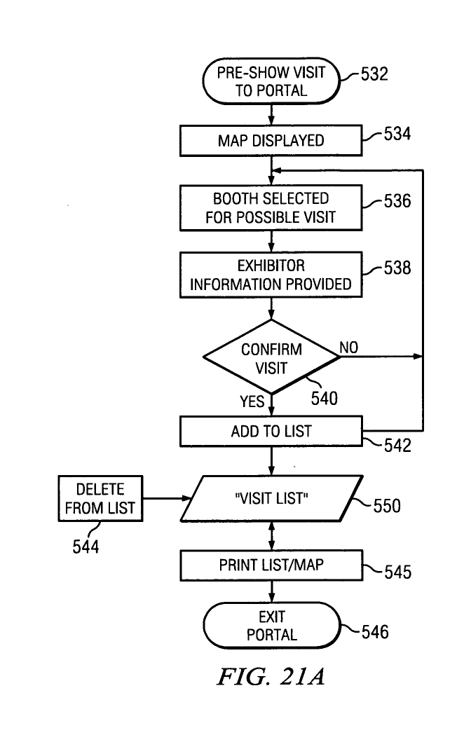

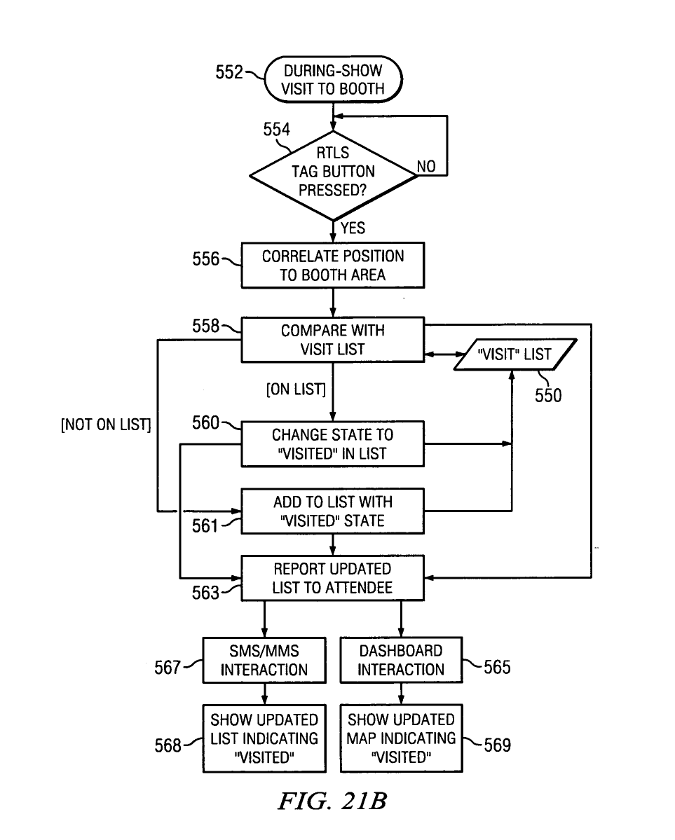

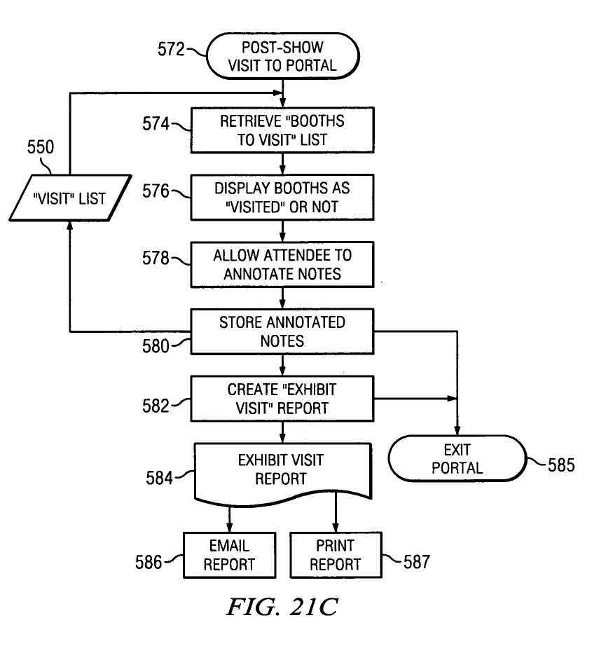

The RTIMS/RTLS system provides for a means to aid the attendee in pre-show, at-show navigation and post-show annotation of the MICE event through the navigation tools shown in the block flow diagrams in FIGS. 21A, 21B and 21C. Beginning with FIG. 21A, an attendee visits the portal application prior to the show (MICE event) in event 532. Subsequently, the attendee is presented with a map in step 534 from which the attendee selects various booths and events that they wish to visit based on information sent to the attendee about each exhibitor. For example, the attendee selects a booth for possible visit in step 536. Information about the selected booth exhibitor is shown in the attendee's web browser (in communication with the portal application) in step 538. Then, the attendee either confirms visit location in step 540 or moves to select another visit location via step 536. Once a visit is confirmed, it is added to the “visit” list 550 via step 542. Optionally, information about the attendee's registration at the show can also be used to automatically add to “visit” list 550 list any sessions that the attendee is scheduled to attend. The attendee has the option in step 544 to delete items from “visit” list 550. At any time during the portal session the attendee may print a list of and optionally map items on “visit” list 550 via step 545. The portal may be exited in step 546. Alternatively, in step 545 the attendee may request that “visit” list 550 in either text or map form be sent via SMS/MMS text message to the attendee's cell phone. The portal may be exited in step 546.

During the MICE event, the RTIMS server will keep track of the booths actually visited by the attendee. Either by SMS/MMS interactions or via the Dashboard, an attendee can compare what they have visited against what they planned to visit. They can request a map that indicates where they currently are located and how to get to any other location at the event.

The at-show process is described with the help of steps 552 through 569 of FIG. 21B. In step 552 the attendee visits a booth location of interest. The attendee signals a visit of this booth location in step 554 to the RTIMS via the attendee's RTLS tag or optionally by sending an SMS/MMS text message. In step 556, the RTIMS correlates the attendee's location to the closest booth location of an exhibitor, a booth location being the geospatial zone containing the booth area, In step 558, comparing the correlated exhibitor with exhibitors on “visit” list 550 which is updated according to whether the exhibitor is currently included in the list or not. If the exhibitor is included in “visit” list 550, step 560 updates the status of the correlated exhibitor in “visit” list 550 to “visited”. If the exhibitor is not included in “visit” list 550, the correlated exhibitor is added to “visit” list 550 with status “visited” in step 561.

At any time while attending the show, the attendee may request an updated report in step 563 of “visit” list 550 via SMS/MSS interaction step 567, on their cell phone for example, or via dashboard interaction step 565 on a web-enabled application on a cell phone or local computer terminal, for example. The updated report is delivered to the attendee in step 568 as a textual list or in step 569 as a graphical map.

After the MICE event, the attendee can visit the portal in order to experience reporting about their navigation of the event, for instance, the attendee may see exhibitors that were visited and pre-selected exhibitors that were missed. They can also annotate information about their visit experience and export it as a report for the consumption of supervisors or other interested parties. The post-show process as indicated by steps 572 through 585 of FIG. 21C may occur at the end of one day of a multiday MICE event or may occur at some time later, say two weeks after the event concludes.

An attendee begins the post show process by visiting the portal application in step 572 and requesting the portal to report visit activity in step 574 which retrieves “visit” list 550. A display of “visit” list 550 is created in step 576 wherein exhibitors listed therein have status indicated as “visited” or “not visited”. The portal application then provides a means for the attendee to annotate informational notes about each “visited” exhibitor in step 578 and then, in step 580, stores the annotated notes with “visit” list 550. At a later time, or upon completion of annotating “visit” list 550, the attendee, in step 582, may create an “exhibit visit” report 584. The post show process completes when the attendee exits the portal application in step 585. Exhibit visit report 584 may be emailed in step 586 to a given set of email addresses and may alternatively be printed locally via the attendee's web browser in step 587.

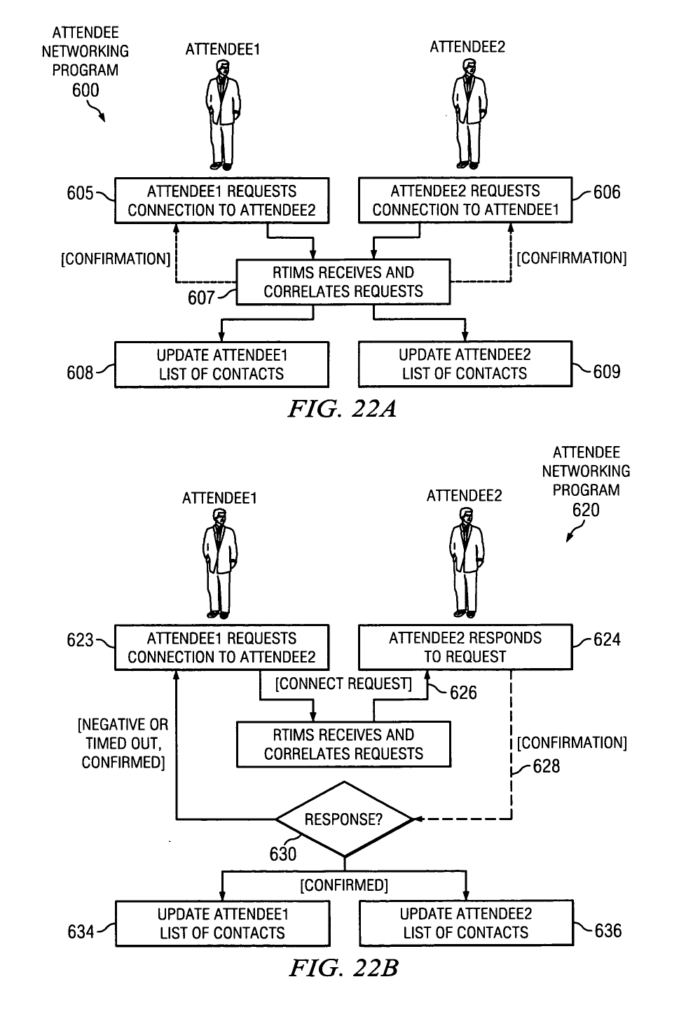

During the MICE event, each attendee has the ability to create connections to other attendees at the event. FIG. 22A shows a flow diagram of method 600 wherein two attendees make such a connection. If two attendees request of the RTIMS server to make a connection, attendee1 via request 605 and attendee2 via request 606, the connection will be recorded by RTIMS server in step 607. These connections are private to each attendee and are independent of the event. The connection gives one attendee access to the contact information of the other attendee; attendee1's contact list in the portal is updated to include attendee2 contact information in step 608 and attendee2's contact list in the portal is updated to include attendee1 contact information step 609. The connections and contact information can be viewed and managed post-show within the portal application. Confirmation of an established connection can be optionally delivered to each attendee's cell phone. Requests to connect may be made by RTLS tag or by SMS/MMS messaging.

Restraints may exist on connection requests via method 600, for example, requests may not being honored unless they fall within a pre-defined time window between requests. Typically, the attendees requesting connection are in communication with each other or in close physical proximity to one another.

An alternate embodiment is method 620 of FIG. 22B wherein attendee1 issues request 623 to establish a connection to attendee2 who is presently unaware of attendee1. RTIMS server receives the request as an SMS/MMS text message containing, for example, attendee2's last name and company. RTIMS server then correlates the received information to attendee2 and passes the request on to attendee2 as a SMS/MMS text message 626. Note that attendee2's cell phone number or RTLS tag identifier must be looked up in the RTIMS database to accomplish request 623.

Attendee2 may respond 624 to attendee1's connection request with an affirmative or negative confirmation 628 which is assessed in step 630. The response is forwarded to attendee1. If the response is not received in a pre-defined time limit, or the response is negative nothing happens. If the response is confirmed positive, then attendee1's contact list in the portal is updated to include attendee2 contact information in step 634 and attendee2's contact list in the portal is updated to include attendee1 contact information in step 636. The connect request 626 from the RTIMS server may alternatively be an audio sound or message generated by the RTLS tag.

During the MICE event, an attendee can request, via SMS/MMS communication or a dashboard application, the physical location of a second attendee to which they have previously established a connection. The RTIMS server will produce for the attendee a map indicating their current physical location and the location of the physical location of the second attendee.

A locator process 650 for locating attendees is shown in FIG. 23 which indicates a physical location request and the RTIMS actions that result. Attendee 1 begins locator process 650 by submitting a request 654 for the location (coordinates) of attendee2. RTIMS receives the request in step 656, querying the RTIMS database 660 in step 658 to confirm that attendee2 and attendee1 have previously established connection to one another. If RTIMS database 660 does not confirm that a connection has been established, an appropriate message is sent back to attendee1 to that effect in step 659 and locator process 650 is terminated. If RTIMS database 660 confirms that a connection has been established the then locator process 650 continues with step 662 to query RTIMS database 660 for the coordinates of attendee2. Meanwhile, in tracking process 663, the RTLS system is tracking attendee2, and RTIMS system is logging attendee2's coordinates into the RTIMS database 660.

The most recent coordinates of attendee2 are returned from RTIMS in step 662, if attendee2 has been tracked at the MICE event, otherwise a null or equivalent is returned to step 662. Locator process 650 continues in step 664 by generating a map indicating the coordinates of attendee1 and the coordinates of attendee2. The map so generated in step 664 is made available for display to attendee in the portal in step 666.

A confirmation of a “successful” or “unsuccessful” location may be sent back to attendee1. As a part of the confirmation message or, alternatively, as a part of the map display, the time of the last successful RTLS location of attendee2 may be displayed. In an alternate embodiment, the map may be sent to attendee1's cell phone or the attendee may be instructed to view the map on the dashboard application. In another alternate embodiment, locator process 650 may run continuously so that the displayed map may be updated continuously with the coordinates of both attendee1 and attendee2.

In another aspect, the RTIMS system may have an appliance to track RTLS tag affinities. Affinity is a figure of merit proportional to the amount of time that the geospatial zone surrounding one RTLS tag is overlapped with a second RTLS tag. Affinities are for each RTLS tag and thus each person are stored in the database files. One useful tool delivered by the portal during and after the event is to provide a list of affinities for an attendee or for a sales person. The list of affinities effectively becomes a prioritized networking contact list and provides the attendee or sales person with direct information about what persons or exhibitors they spent the most time with during the event. A networking graph may also be constructed from the list of affinities. It readily understood that the affinity appliance is a useful tool for social networking events.

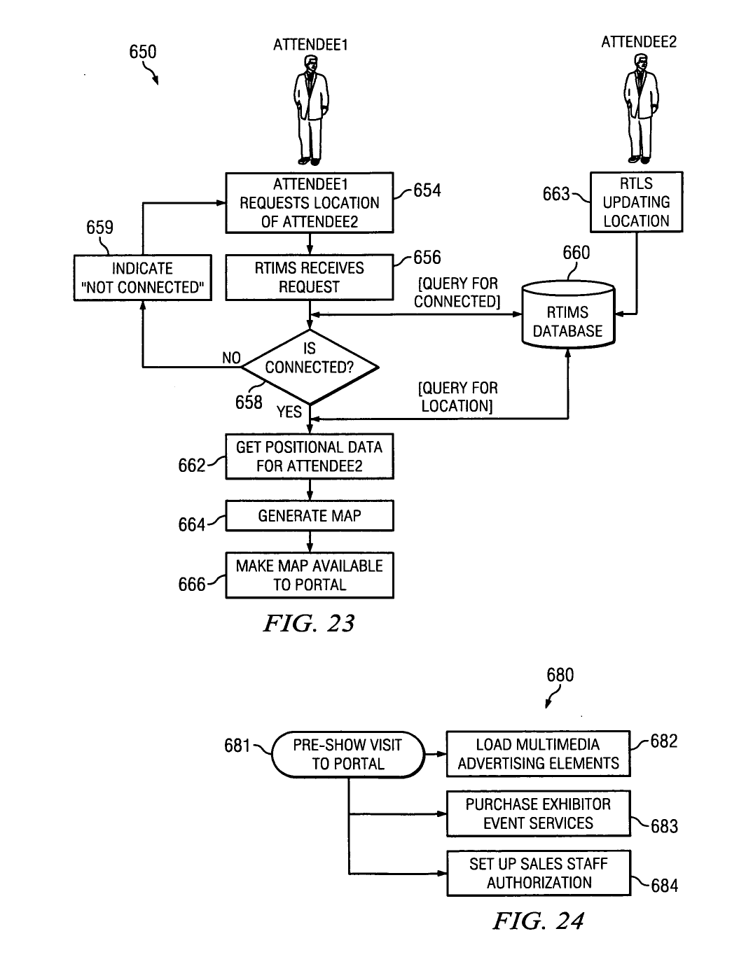

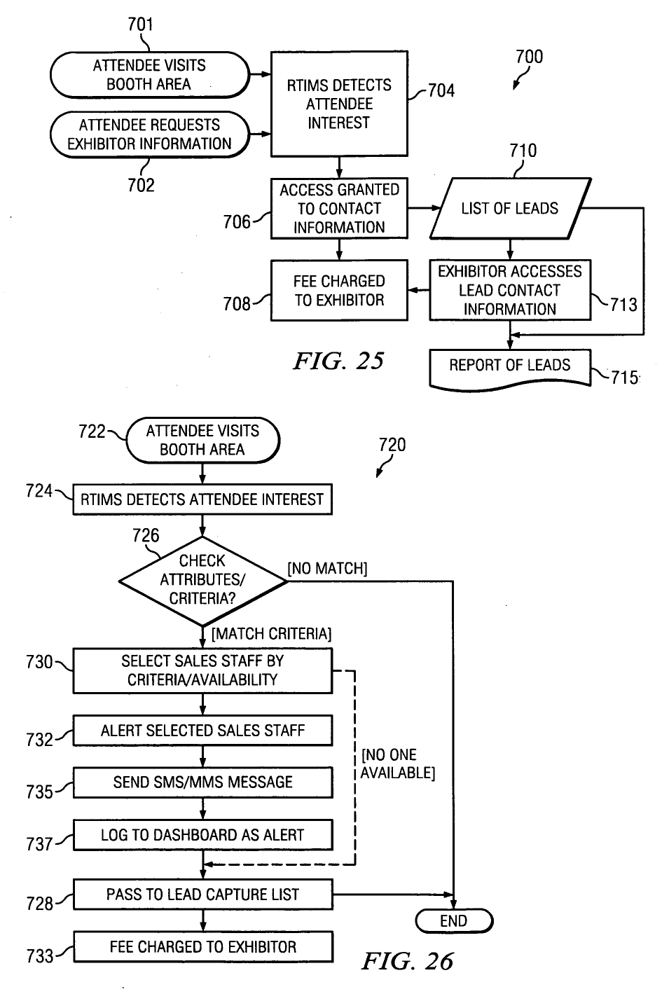

Other applications that benefit the exhibitor are provided. In a first example of such an application, exhibitor services setup process 680 is shown in FIG. 24, each exhibitor is able to visit, in step 681, the portal application prior to the show (MICE event) in order to load multi-media elements 682 that can be used in advertising. Exhibitors are offered the opportunity to purchase services 683, such as SMS/MMS messages to attendees passing by the booth in order to entice them to visit the booth. In step 684, sales staff may be set up in the RTIMS system, given specific authorizations and attributes for utilizing the RTLS and RTIMS system and for handling sales lead capture events as will be explained in relation to FIG. 25.

Another exhibitor application is indicated in the lead capture process 700 of FIG. 25. An attendee's request 702 for more information from the exhibitor and a simple event 701 wherein the RTLS system reports that an attendee entered the physical space of the exhibitor's booth is detected by the RTIMS system in step 704. As a result of the detection, access may be granted the exhibitor to the attendee's contact information in step 706.

The contact information and visit information will be collected as lead information for the exhibitor to analyze, annotate and distribute to Sales Staff. When the contact information is released to the exhibitor, the contact information is included in the list of leads 710. The exhibitor accesses the contact information in step 713, with the ability to annotate the list of leads 710 and the ability to request a report 715 of the list of leads 710. The exhibitor may be charged a fee to receive the contact information and to gain access this information as in step 708.

In yet another application conceived for the exhibitors benefit, the exhibitor can set up alerts for events such as a particular attendee or an attendee meeting certain criteria arriving in the booth as detected by the RTLS. The RTIMS will then send an SMS/MMS message to the Exhibitor and Sales Staff of their choosing to be notified of this event.

A representative exhibitor alerting process is shown in FIG. 26. Alerting process 720 is initiated with event 722 wherein an attendee visits the exhibitor location such as a booth. RTIMS system detects the attendee in step 724 and begins a process to determine if the attendee is of sufficient interest to cause an alert to be sent to a sales staff person. Step 726 checks attendee attributes for comparison against pre-defined attributes to establish an alert, for example: company, title, and key words in the attendee's description. If there is no match, the alerting process 720 terminates. If some attributes do match, then a sales staff person, preferably on-site, is selected in step 730 and alerted in step 732. The alert may occur, for example, by sending SMS/MMS message 735 to the selected sales staff or as an alert message 737 on the exhibitor dashboard application. The alerting process terminates by at least capturing the attendee information and time of arrival in lead capture event 728. If no sales staff is available, the lead is still captured for later follow up in lead capture event 728. A fee may be charged in step 733 for the lead capture service.

Post-show, information is processed by the reporting system and reported to exhibitors via the portal application concerning:
a. attendee visits to or near the Exhibitor's booth (in aggregate and categorized) (fee may be charged for this service),
b. staff interactions with attendees,
c. detailed reporting on demographics and movements of individual attendees,
d. Scatter-map analysis (including movies depicting movement) of attendee traffic at the show.

The portal and dashboard applications recognize, through the authentication process at log-in, what type of user (attendee, exhibitor, sales staff, show organizer) is accessing information and responds with appropriate levels and types of information.

Several examples of applications that benefit the attendee and the exhibitor have presented. The present invention also enables many conceivable applications that benefit the show organizer.

Show Organizers are provided access to a “show organizer” dashboard application in order to experience live information concerning RTIMS activity within the entire event. This includes a map component that shows live positions and movements of every attendee at the event in addition to reporting significant metrics.

Post-show, information is processed by the RTIMS system and reported to show organizers concerning:
a. attendee visits to or near every exhibitor's booth (in aggregate and categorized),
b. attendee traffic at arbitrarily defined areas of the event,
c. detailed reporting on demographics and movements of specified individual attendees,
d. scatter-map analysis (including movies depicting movement) of attendee traffic at the MICE event.

Prior to and during the MICE event, the RTIMS server populates the RTIMS database with information concerning the event and its environment. Attendees and exhibitors may query the database via SMS/MMS messaging or the dashboard application. For instance, the attendee can request local weather and radar images, information about training or other event related sessions starting in the next 30 minutes, maps of the facilities, and information about local restaurants, event hours, emergency contact numbers and procedures.

Within the portal application, each attendee will be able to specify and control what contact information is provided to each exhibitor that is granted access to the attendee's contact information. Sales staff are provided access to the leads assigned to them by the exhibitor. The portal access can include browsing, analyzing and exporting of the lead data.

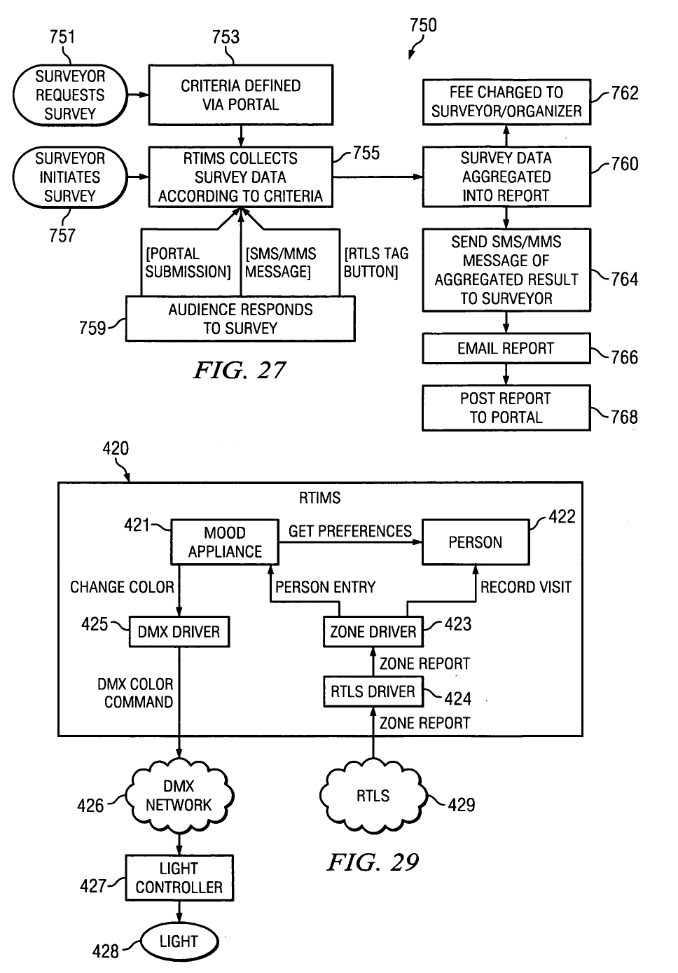

Show Organizers and Exhibitors can survey attendees in an interactive audience response system application using the RTLS/RTIMS systems in order to collect actionable data from the survey. FIG. 27 depicts a flowchart of an exemplary embodiment of a survey process 750 enabled by the present invention. In the exemplary embodiment, the surveyor may be, for example, a session speaker, an exhibitor or a member of the press. The surveyor makes a survey request 751 through purchase agreement or similar means utilizing the portal application. In step 753, the surveyor defines criteria about the survey such as the survey question(s), response constraints, attendee constraints such as registration type and location, time window for response once the survey is initiated, where to send the results and statistical data required. The RTIMS system collects the survey criteria through the portal application so that when the surveyor initiates the survey in step 757, the RTIMS system in step 755 begins collecting the survey response according to the collected criteria.

The audience of the survey may respond in step 759 by one of the method of submitting a response through the portal application, the method of SMS/MMS messaging the response and the method of pressing one or more RTLS tag buttons. Other means for response are possible.

In step 760, survey responses collected by the RTIMS system are aggregated into a report according to the collected criteria. An SMS/MMS message of the aggregated result may be sent to the surveyor in step 764 for immediate feedback which may be used to influence the activity in which the surveyor is engaged. For example, a session speaker may orient the remainder of his presentation based on the survey results. A more comprehensive report may be emailed in step 766 and may be posted to the portal application in step 768 for later review by the surveyor. A fee may be charged for the survey service in step 762, wherein the fee may comprise a set up fee, a per instantiation fee and a per response fee. Surveys may be repeated for use on an individual basis, for example, a surveyor may target a specific attendee at a specific time for a response to a survey question.

The invention also supports the use of RTIMS enabled hand-held computers carried by sales staff. The RTIMS system associates the hand-held computer with the appropriate sales staff member and can interact with them via wireless Ethernet for the purposes of providing information about an attendee standing nearby and for collection of survey responses from them.

An additional alternate embodiment incorporates the use of a handheld computer device such as a smart phone device with an integrated RTLS tag in place of a cellular phone and separate RTLS tag. The attendee would wear the device on a lanyard and the delivery of services to the attendee would be done using a Graphical User Interface (GUI) rather than relying on SMS/MMS messaging. The handheld computer device would include an exterior speaker, a vibrating alert system, and a headphone port.

In alternate embodiments, active RFID technology can be used in place of RTLS in order to deliver a subset of the value represented by the invention. Active RFID provides only presence information within a monitored area and requires an impractical amount of equipment to monitor the entire event space.

An additional alternate embodiment includes the use of a web browser on the cellular phone to provide attendee access to their personal dashboard application and/or their personal portal application. This functionality would replace some SMS/MMS interactions where appropriate.

Another alternate embodiment includes connecting kiosks placed around the event space to the RTIMS network in order to deliver access to the dashboard and/or portal.

The concept of delivering relevant value to attendees that interact with an RTIMS system in implicit exchange for attendee data capture and measurements during the MICE event is characterized as reciprocity. A reciprocity also exists for the MICE event organizer, wherein the MICE event organizer may enable facility or other functions for the exhibitor in exchange for exhibitor data such as the number of actionable booth visits. A useful tool for delivering adequate reciprocity and for organizing the equipment, networking and computational needs for a MICE event is a data generation plan.

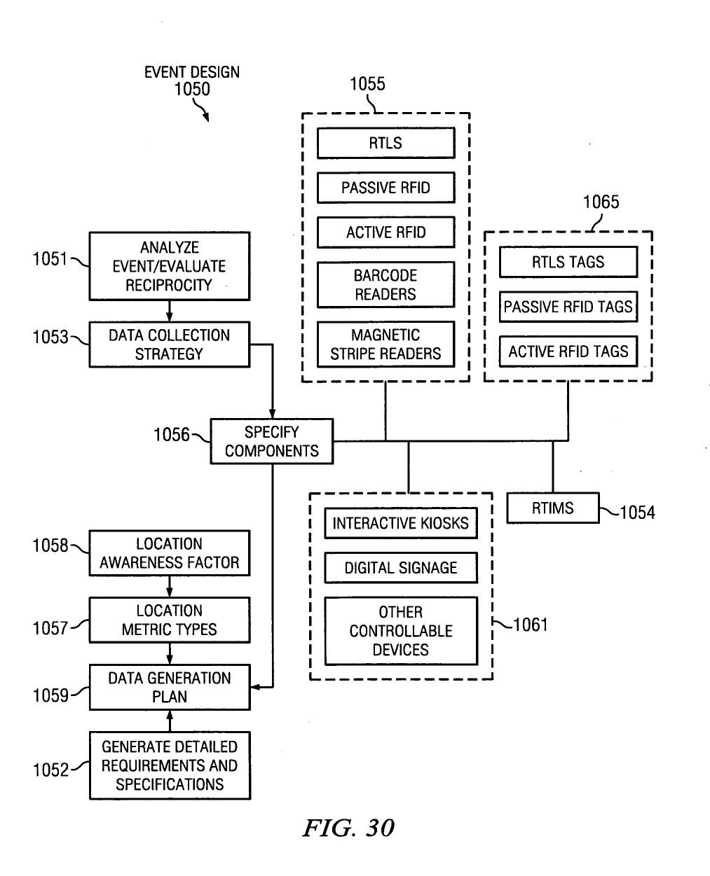

In a further aspect of the present invention, a data generation plan is consolidated from a data collection strategy and a set of components into a comprehensive event design as shown in FIG. 30. Considering the process of event design 1050, a MICE event is analyzed in step 1051 to establish goals for reciprocity between the attendees, exhibitors and organizers associated to the event. The data collection strategy is a strategy to meet the goals of reciprocity for the event in terms of generating and capturing relevant data for the MICE organizer and in terms of delivering targeted and personalized information and services to the attendee. The data collection strategy more generally looks at all aspects of the flow of data to and from the various entities involved in the MICE event that have potential to create or receive value, for example, the MICE organizer, the attendee, the exhibitor, the exhibitor sales staff, the technical speaker, the local event vendor and the event facilities owner.

Once data collection strategy 1053 is defined, a set of components is specified in step 1056 including a proprietary real-time marketing system (RTIMS) 1054, a set of locating systems 1055, a set of locatable tag devices 1065 and a set of controllable components 1061. The set of locating systems 1055 may be selected from the group of a RTLS, passive RFID system, active RFID system, barcode readers and magnetic stripe readers. The set of locatable tag devices 1065 may be selected from the group of RTLS tags, passive RFID tags and active RFID tags. The set of controllable components 1061 may be selected from the group of interactive kiosks, digital signage, and other controllable devices capable to create ambient intelligence.

The equipment in the specified set of components is a combination of existing off the shelf equipment with open interfaces that can be integrated into an experience and proprietary software frameworks that may be rapidly customized for the needs of the event. To this end, a detailed requirements and specifications for deployment are generated in step 1052 to implement the data generation plan 1059 at the event. Collectively, RTIMS 1054, set of locating systems 1055, set of locatable tag devices 1065, set of controllable components 1061, data collection strategy 1053 and the detailed requirements and specifications of step 1052 represent a data generation plan 1059 for the mice event.

Data generation plan 1059 is deployed at the MICE event for which it was designed and runs in real-time during the event. Data generation plan 1059 interacts with, measures and may govern, the event environment according to the detailed event design 1050 utilizing the mechanisms as described in connection with FIG. 11.

Referring again to FIG. 30, event design 1050 is characterized by location metric types 1057 and a location awareness factor 1058 which is a measure of location information incorporated in the data generation plan. Known quantities of locating systems with a known location metric type 1057 are deployed in a MICE event according to data generation plan 1059. The location metric type provides for an accurate and precise qualification of a locating technology and may be used in part to assess the location awareness factor.

In a preferred embodiment, location awareness factor 1058 is a value that varies from 0.0 (zero) to 1.0 (one) wherein an event design with zero location awareness had no RTLS, RFID or similar equipment involved in the event.

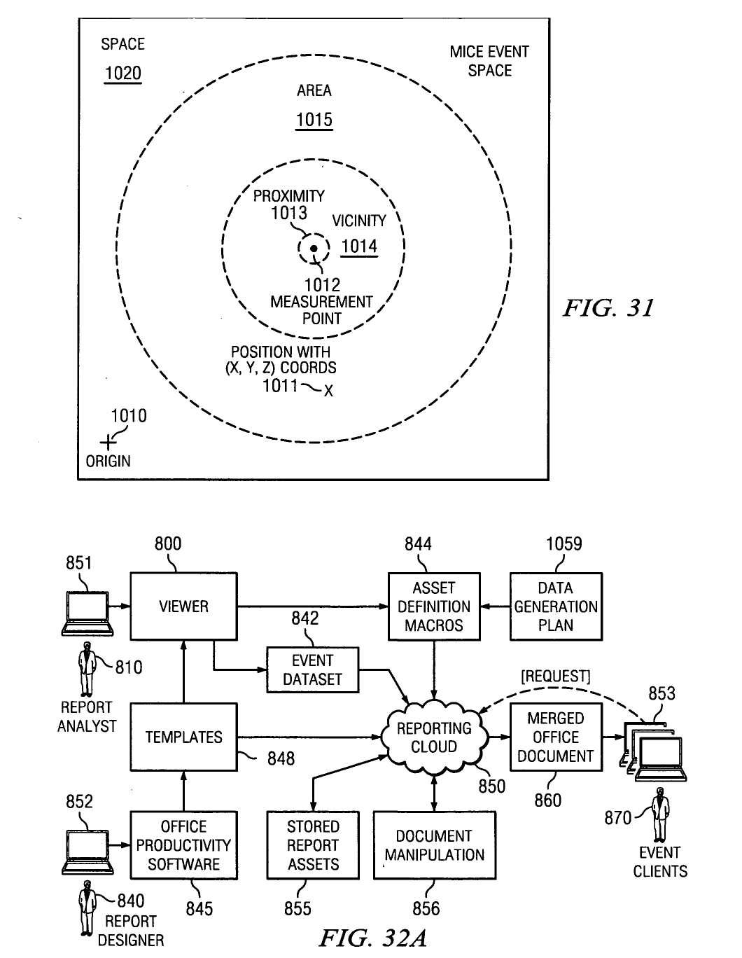

Location metric types 1057 are defined with respect to a measurement point and an object location as shown in FIG. 31, the measurement point 1012 being the position of a location measuring device in a predefined MICE event space 1020 wherein measurement point 1012 is at a fixed set of coordinates, generally defined in three dimensions and referenced to a predefined origin 1010 of coordinates in the MICE event space. The object location is the metric reported by the locating technology during a location event. The location event may be triggered by a change in the object's location.

In the description that follows, note that the size of the circles drawn in FIG. 31 to depict various areas in the MICE event space are not necessarily drawn to scale with respect to each other.

Location metric types for an object are preferably position, proximity, vicinity and area types. An alternate embodiment may also include a space type.

The position location metric is an object location which is ultimately independent of a measurement point—it is a measured set of coordinates 1011 of the object, relative to the predefined origin in the MICE event space. Accuracy of the position location metric is about +/−15 (fifteen) cm.

The proximity location metric is preferably a location metric type wherein the object location is an affirmation that the object is within about 5 (five) cm of the measurement point. The proximity location metric is represented by the area enclosed by circle 1013.

The vicinity location metric is preferably a location metric type wherein the object location is an affirmation that the object is within the range of about 1 (one) to 2.5 (two and one-half) meters of the measurement point. The vicinity location metric is represented by the area enclosed by circle 1014.

The area location metric is preferably a location metric type wherein the object location is an affirmation that the object is within about 7.5 (seven and one-half) meters of the measurement point. The area location metric is represented by the area enclosed by circle 1015.

The space location metric is preferably a location metric type wherein the object location is an affirmation that the object is contained within the MICE event space. The space location metric is represented by the area enclosed by MICE event space 1020.

A suitable location technology having the position location metric type is the Series 7000 UWB RTLS platform from Ubisense Ltd. A suitable location technology having the proximity location metric type is a passive RFID complying with standard ISO/IEC 14443. A suitable location technology having the vicinity location metric type is a passive RFID complying with standard ISO/IEC 15693. A second example of the vicinity location metric is the ActiveTag™ product line from Axcess which has a range near 2.5 meters. A suitable location technology having the area location metric type is the UHF RFID EPC Gen 2 from Alien. An example of the space location metric type is a set of vicinity sensors arranged in pairs near all doorways to the space, so as to detect, report and correlate the movement of objects into and out of the space.

The location metric definitions as given match the performance and standards of existing off-the-shelf locating technologies. However, the definitions provided should not be interpreted as limiting the invention and merely representative of the preferred embodiment. In other embodiments the location metric definitions may be different. For example, the range definitions may vary from 30% to 300% of the given values for a given MICE event, or between a set of MICE events and/or between MICE organizers. However, in a preferred embodiment system that quantifies the location awareness factor, it is important to keep the definitions of the location metrics fixed across multiple data generation plans so that the location awareness factors can be computed and compared between event designs.

Additionally, the location metric for any of the location metric types allows for one of either identifiable objects or non-identifiable objects. An identifiable object metric type indicates that the locating technology is capable of producing the identity of an object triggering a location event and report. A non-identifiable object metric type indicates that the locating technology is not capable of producing the identity of an object triggering a location event and report. An object identity may be, for example, an RTLS tag identifier.

Various examples of the process to obtain a data generation plan are now provided to clarify the invention. In an example of step 1051 of analyzing an event, the event participants including exhibitors, organizers and a subset of attendees may be interviewed and their goals and strategy are identified for the event. The goals include what information needs to be collected to determine a positive return on investment for the event participants based on their types of business and their revenue models. Additionally, a determination is made of the type of value exchange to occur between the exhibitors and the attendees that visit their booths. This value might be tangible items such as booth prizes or intangible items such as subsidized services that the attendee benefits from at a later time. The attendee may be required to submit a survey providing valuable information to the exhibitor. For example, the survey may obtain information about how a particular exhibitor product is used by the attendee. The information gathered about these exchanges is used to form data collection strategy 1053.

Data collection strategy 1053 is designed with the event participant considering how to execute the “value exchanges” that have been identified. Creative experiential design is coupled with a menu of equipment and desirable software functionality. For example, the event client might be given proposals for an interactive Kiosk to survey people, some free SMS services to assist visitors while at the event and RTLS passive measurement to gather implicit interests. The tactical data collection design is decided upon from these interactions.

Data generation plan 1059 is the fusion of the other elements into one cohesive strategy. At this level, all questions are answered about what pieces of technology will be involved and how each value is exchanged. After this point, the data generation has detailed requirements and specifications added to accomplish the deployment. For example, a particular kiosk home page will show a specific video while waiting for someone to interact with it. The data generation plan may also be characterized as the level of detail and content required to begin logistical planning and implementation of the event design. Thus, an event design is complete when a data generation plan is defined. The event design is then implemented at the event.

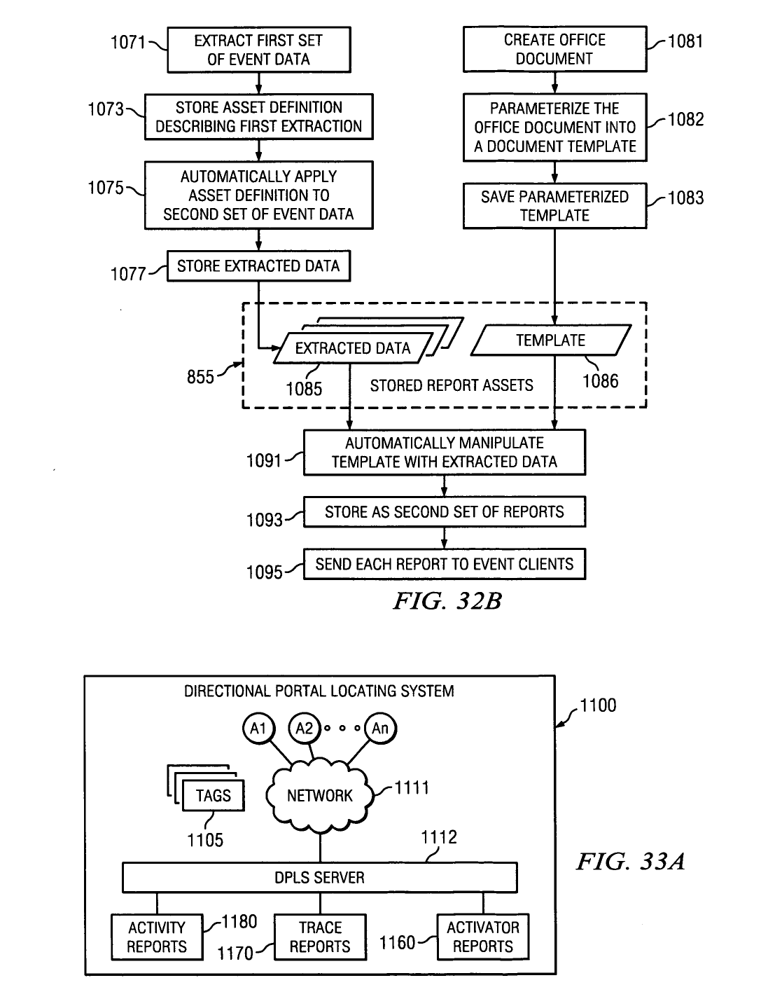

Turning to FIGS. 32A and 32B, further details describing an embodiment of the reporting function of the reporting system of the present invention are shown as a use case and flow chart, respectively. Beginning with FIG. 32A, a reporting cloud 850 is shown which is communicatively connected to a first computer terminal 851, a second computer terminal 852 and a set of client computers 853. Reporting cloud 850 comprises a computer network, which may operate over the internet to serve files, containing a set of interconnected computer servers with digital memory and data storage capability. A report analyst 810 uses viewer 800 operating on first computer terminal 851 to analyze an event dataset 842 using methods similar to those described in relation to FIGS. 16A, 16B, 17A, 17B, and 17C. Report Analyst 810 may use the data generation plan 1059 for an event to extract data from event dataset 842 while operating viewer 800 to author a set of asset definitions 844 which is a recorded set of operational instructions which may be used to further extract event data in an automated way.

A set of document templates 848 may be used to define the data to be extracted from the event data set. The set of document templates 848 are created by a report designer 840 while using an office productivity program 845 operating on second computer 852, office productivity program 845 having the capability of storing original office type documents in an open XML format. The office type documents may be one or more of a spreadsheet, a presentation, a word processing document capable of retaining text and/or graphics, drawing document and a database file. In creating the office type documents, the report designer parameterizes some of the normal elements of the documents and saves the parameterized documents in the set of document templates 848. Parameterization means that a stored document template can be opened in its XML format and manipulated in standard ways using external data.

The set of asset definition macros 844 and set of document templates 848 are sent to reporting cloud 850 where they are stored together as set of reports assets 855 wherein each report asset is stored in the context of its event dataset.

A document manipulation program 856 operates in the reporting cloud to perform document manipulations. The document manipulation program is capable to generate a plurality of documents in the same native format as the original office type documents by applying automated and repeated manipulations of document templates 848 to create reports in the format of merged office documents 860 which may be sent to the set of client computers 853 for review by event clients 870. Examples of such document manipulation capabilities include, but are not limited to: (a) replacing specific patterns of text in a document with external data driven values, (b) updating graph data and a graph from external data driven values, and (c) creating a duplicate set of presentation slides from external data which includes a list for which a duplicate presentation slide is generated for each member of the list.

The created reports are office type documents in native format that contain event data specific to event client requests. The reporting cloud is then capable of automating this process for a large number of event data sets, the reporting system thus capable to produce a large number of native office productivity format documents suitable for delivery by email to event clients 870 in their respective organizations.

Set of asset definition macros 844 and set of document templates 848 represent a higher level parameterizable process as they define how the data is extracted from event data sets and also how the data is merged with document templates to create reports. Report Analyst 810 may use viewer 800 to merge data from event dataset 842 into a set of reports by applying asset definition macros 844 to one or more of the set of document templates 848. However, in practice it is preferred to merge the event data and the document templates into reports at a later time, when requested by an event exhibitor or event organizer (event clients).

Reporting cloud 850 may be programmed to apply document manipulations in an automatable and scalable process to create reports from the set of report assets 855 based on requests from event clients 870 such as event exhibitors or meeting organizers.

Turning now to FIG. 32B, the operational method for using the reporting system of FIG. 32A to create event client reports from event data is shown in the form of a flow chart. In step 1081, an office document is created using an office productivity program operating on a first computer terminal. The office document is created to provide a report for an event client, for example, a spreadsheet histogram graphic embedded in a presentation slide showing the number of booth visitors for several visitor categories. Preselected elements of the office document are then parameterized to create a first document template in step 1082. In one method of parameterization, the preselected elements are typed in as specific text patterns that may be unlike the normal textual context of the office document, for example as “%data1%”, “%category1%”, “%data2%”, “%category2%” etc. Step 1083 is then performed to save first document template in the reporting system computer network, preferably as an xml format file. Steps 1081, 1082 and 1083 may be repeated to create and save a plurality of stored document templates.

Step 1071 may be performed prior to step 1081, at the same time as step 1081, or after step 1081. In step 1071, a viewer application program operates on a second computer terminal to extract a first set of event data from event information files gathered during an event by a real-time marketing system. The viewer application is further operated in step 1073 to record and store an asset definition describing the extraction of the first set of event data is recorded, the asset definition being capable to replay the extraction on event information files or a similar set of event information files. The asset definition is stored as a file in the reporting system computer network. Step 1075 may automatically apply the asset definition to the event information to extract a second set of event data. In step 1077 the second set of extracted data is stored in the reporting system computer network. Steps 1075 and 1077 may be repeated for a plurality of asset definitions that had been previously created according to repeated applications of steps 1071 and 1073, the result being a plurality of extracted data sets. The second set of extracted data, plurality of extracted data sets, the first document template and plurality of stored document templates comprise stored report assets 855.

At a later time, preferably at the request of an event client, a data manipulation program operating on the reporting system computer network, may manipulate the parameterized elements of the document template into a report document in step 1091. The manipulation in step 1091 is done according to data contained in the second set of extracted data. As an example of the manipulation step 1091, the set of extracted data may contain a portion of data related to booth visitor categories and number of visits, so that a first visitor category is “managers” with a first category visits of “132”, a second category of “executives” with a second category visits of “35”. The data manipulation program may: find %category1% and replace it with “managers”, find %data1% and replace it with “132”, find %category2% and replace it with “executives”, find %data2% and replace it with “35”, and so on.

The reporting system method continues with step 1093 of storing the report document in the reporting system computer network and finishes with the step 1095 of automatically sending the report document to the an event client associated to an event in the set of events.

The goal of the native office productivity file format for the document template is to give the event report information more adaptability and flexibility as it enters the client organization. Furthermore, the documents are delivered in editable form so that the event clients can fashion the reports to suit their own organization's needs. Such actionable and leverageable information provides for increased value to the event client.

Examples of native office productivity documents suitable for the present invention are documents from the Microsoft Office 2007 version of products including “Word”, “Excel”, “PowerPoint”, “Access”, and “Visio”.

In another embodiment of the reporting function of the present invention, dwell times may be associated to geophysical zones, and report templates may be used to capture the information for event clients. The MICE event facility is divided into geophysical zones, which may be exhibitor booths or other areas of interest within the facility. The positional coordinates of an attendee is normally captured as a time series by a RTIMS system incorporation with a RTLS control system. Dwell time may be measured in a post processing application as the total time that a zone is occupied by a participant. A histogram of attendee dwell times for a given zone may be generated by computing the dwell time of all participants for that given zone and counting the number of participants with various dwell times. A report may be generated as a histogram for a zone, an aggregate average dwell time for a zone, an average dwell time by particular attendees or an average dwell time for a set of attendees with common attributes.

In this example, the dwell time may be computed as follows:

$${T}_{i} ( Z ) = {\sum }_{j} ( {t}_{j} - {t}_{j - 1} ) \cdot {IN}_{Z} ( {P}_{i} ( {t}_{j} ) )$$

where Pᵢ(tⱼ) describes the position of the i^{th} participant at the time tⱼ, IN_{z}(P) is a function that returns a 1 if the position P is located inside the zone Z and returns a 0 if the position P is located outside the zone Z, Tᵢ(Z) is the total dwell time of the i^{th} participant in zone Z.

In relation to FIGS. 32A and 32B, a template may be created for a topological map of the geophysical zones of a MICE facility and the template populated using computed dwell times for an event. The topological map of the MICE facility shows all the geophysical zones with the topology defined by an indication of average dwell time per geographical zone.

The indication may be at least one of a color coding, a number and a brightness level on a gray scale drawing.

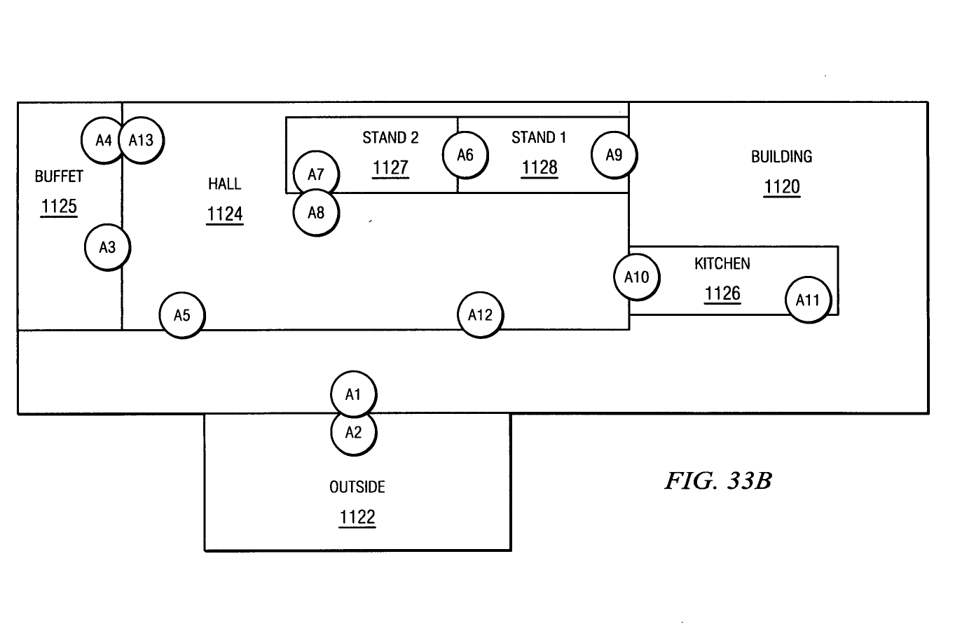

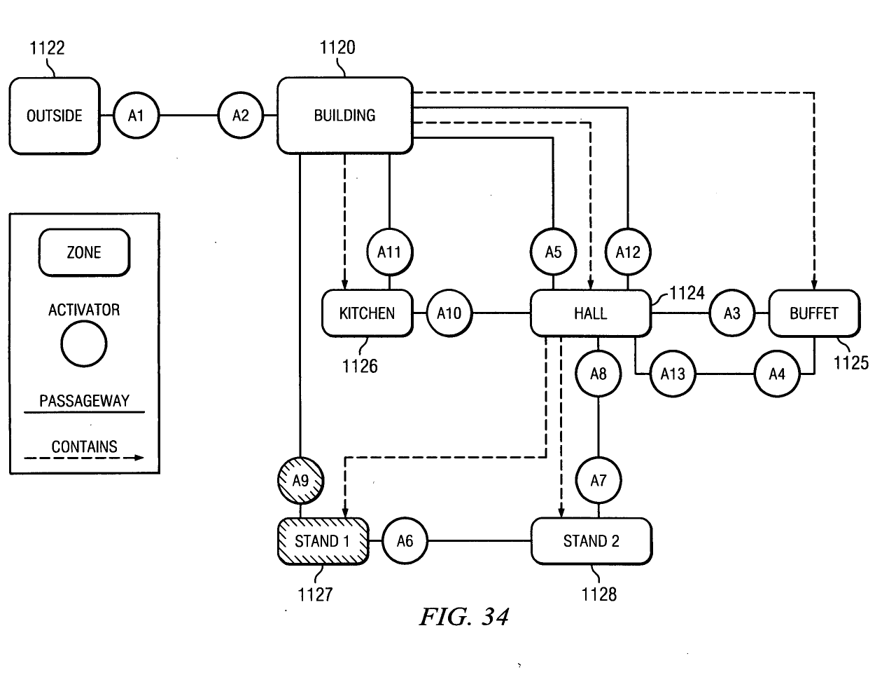

Another embodiment of an RTLS system may be constructed using an array of activators to form a directional portal location system (DPLS). FIGS. 33A and 33B and 34 show a DPLS in the context of a representative use-case example. Beginning with FIG. 33A, DPLS 1100 includes a set of activators A1, A2, . . . An, where n is the number of activators, the set of activators in communication with a DPLS server 1112 via a local network 1111. A set of tags 1105 are each uniquely associated to one locatable object and are capable of being detected and reported as becoming proximate to an activator when in range of the activators according to the activator's location metric type. Each one of the set of activators in DPLS 1100 are comprised of a location technology selected from the group of vicinity and area location metric types and capable to detect a tag's proximity thereto, time of detection and a tag identifier. DPLS server 1112 is capable of collecting a set of activator reports 1160 from the set of activators, and may operate on the collected activator reports to create a set of trace reports 1170 and a set of activity reports 1180.

FIGS. 33B and 34 show an example DPLS application of DPLS 1100 for a set of 13 (thirteen) activators A1, A2, . . . A13 situated in various Zones for an event. FIG. 33B is a physical layout of the DPLS application. An outside zone 1122 contains activator A2 situated near a building entrance. A building zone 1120 contains a hall zone 1124, a kitchen zone 1126 and a buffet zone 1125. The building zone further contains activator A1 situated neat the building entrance. The hall zone 1124 contains stand 1 zone 1127 and stand 2 zone 1128 along with activators A5, A8, A12 and A13 proximate to the building, stand 2, building and buffet zones, respectively. Kitchen zone 1126 contains two activators, A10 and All adjacent to the hall and building zones, respectively. Buffet zone 1125 contains activators A3 and A4, both of which are adjacent to the hall zone. Stand 1 zone contains activators A6 and A9, which are adjacent to the Stand 2 and building zones, respectively. Stand 2 zone contains activator A7 which is adjacent to the hall zone.

To aid in the deployment of DPLS, a cyclic graph as shown in the exemplary graph of FIG. 34 may be constructed from the physical layout. The cyclic graph is the design of how the equipment should be deployed. It is also useful for defining the logic of deployment and may be further construed as a logical state diagram. In the latter sense, FIG. 34 describes the possible states of location (zones) for a locatable object in the example DPLS application. The state diagram indicates the zones, the passageways between zones, the activators, and containment of zones available to the DPLS. The zones are indicated by white and shaded ovals and activators are indicated by white, black and shaded circles. Zones and activators are labeled similar to the corresponding entities in FIG. 33B.

Nesting may be thought of as the containing of one zone within another zone. Dashed lines in FIG. 34 indicate the nesting of zones. For example, buffet zone 1125, hall zone 1124, and kitchen zone 1126 are nested within building zone 1120. Although stand 1 zone 1127 is not nested directly in building zone 1120, there is an available passageway from building zone 1120 to stand 1 zone 1127 via activator A9.

A shaded zone indicates that the locatable object is currently located in that zone. The passageways are indicated by solid black lines between zones and describe the allowed available paths for a location to change from one zone to another zone. For example, the state of the locatable object may change directly from being in the building zone to being in the stand 1 zone, and vice versa.

A white activator indicates that the associated physical activator has not detected the presence of the locatable object. A black activator indicates that the associated physical activator has detected the presence of the locatable object at a time in the past. A shaded activator indicates that the associated physical activator is currently reporting the presence of the locatable object. For example, the locatable object is currently near stand 1 and has not been detected in the kitchen according to FIG. 34.

The DPLS is capable to create a history of locations by storing the states of the DPLS application over time. Preferably, the DPLS application may reconstruct the states of the DPLS application over time, by examining a time series in one of the set of activator reports 1160.

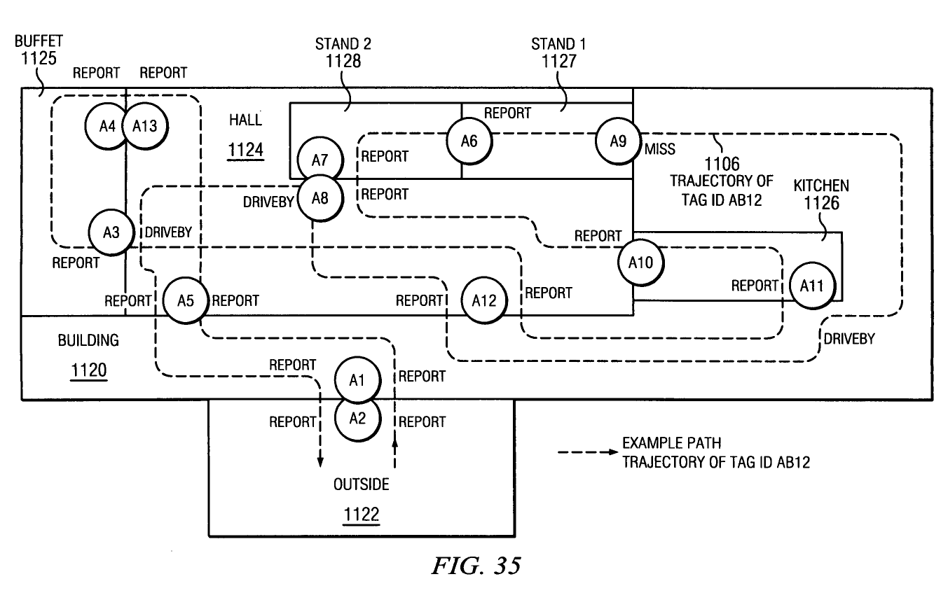

FIG. 35 indicates an alternate view into the use-case example of FIG. 33B wherein a trajectory of a specific locatable object is overlaid on the physical diagram of the DPLS. Trajectory 1106 indicates movement of a locatable object wherein the tag (tag ID AB12) associated to the locatable object is detected and reported at different times by the set of activators within various zones. In the trajectory 1106, note the miss event wherein activator A9 does not detect or report the passing of tag AB12 from stand 1 zone to the building zone. A miss event may occur where a locatable object tag crosses an activator's area of coverage, but various environmental factors prevent the presence of the locatable object tag from being reported, such as RF interference, intermittent tag failure, signal absorption by nearby bodies, etc. Note that various drive by events are labeled, meaning that a nearby activator detected and reported the presence of tag AB12, but in actuality the tag AB12 did not enter the zone containing the nearby activator.

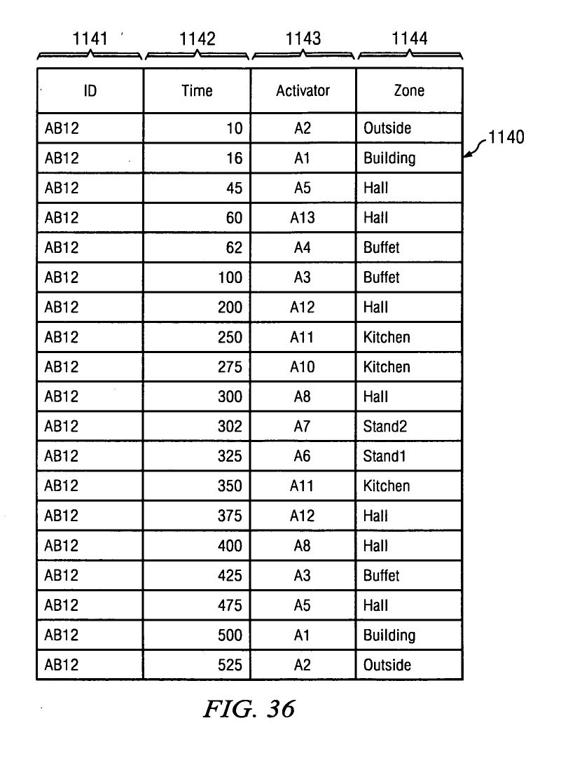

FIG. 36 is a representative example of an activator report 1140 for a tag ID, tag AB12 for example, listing a time series of activator events indicating the tag id 1141 of a reported tag, the time of each activator event 1142, the activator reporting each event 1143 and the zone associated to each reporting activator 1144. Activator report 1140 is representative of one of the set of activator reports 1160 of DPLS 1100 in FIG. 33A.

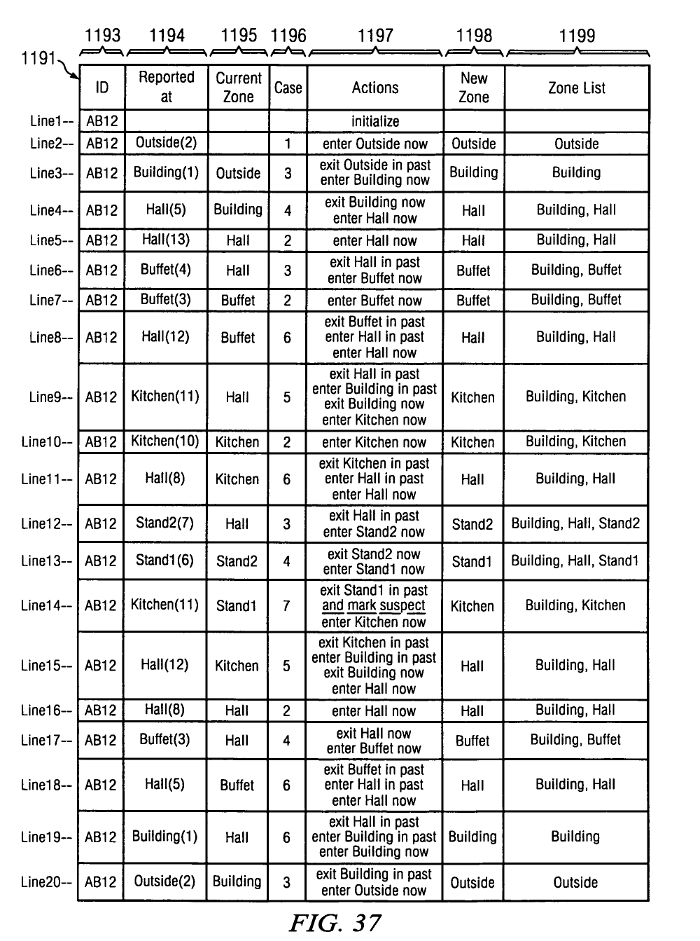

FIG. 37 is a representative example of a trace report 1191 in the set of trace reports 1190. Trace report 1191 contains a set of rows (line 1-line 20, in the example) and a set of columns. Each row corresponds to an activator event in an activator report; in the example data given, the activator report 1140 of FIG. 36 should be compared. The columns contain at least a tag ID field 1193 for holding a tag identifier associated to the reported tag of the activator event, a reported location field 1194 for holding the reporting activator location, a current zone field 1195 for holding the last known zone location of the reported tag, a case field 1196 for categorizing the type of movement (change of state) associated to the activator event, an actions field 1197 for holding details regarding the actions leading to the activator event, a new zone field 1198 for holding a projected new zone location of the reported tag and a zone list 1199 for describing the zone containments associated to the reported tag.

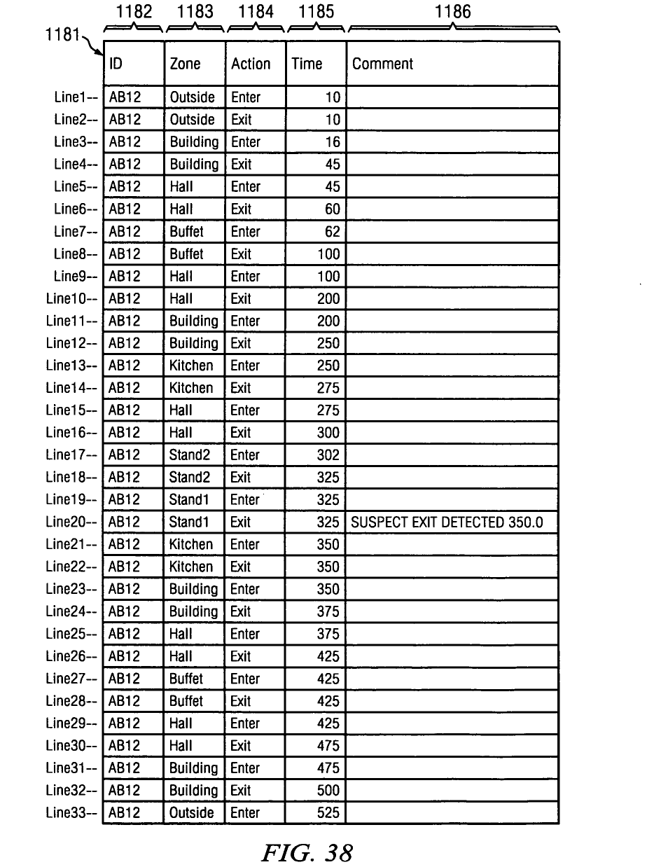

FIG. 38 is a representative example of an activity report 1181. Activity report 1181 contains a set of rows and a set of columns. Each row corresponds to an entry (or exit) activity to (or from) a zone for a given tag identifier; in the example data given, the activator report 1140 of FIG. 36 and the trace report of FIG. 37 should be compared. The columns contain at least a tag ID field 1182 for holding the tag identifier, a zone field 1183 for holding a zone label, an action field 1184 containing one of either “entry” and “exit”, a time field 1185 for reporting the time of the activity, a comment field 1186 for holding exception type information.

The DPLS system is capable of reporting the location of a number of locatable objects at any given time using the activity report. A first illustrative example is indicated by lines 16-19 of activity report 1181 in which it can be seen that the locatable object associated to tag ID AB12 has left the hall (line 16) at time 300 (minutes) to enter stand 2 (line 17) where an entry is detected two minutes later at time 302 (minutes). The locatable object remains in stand 2 until time 325 (minutes) when it is detected near an exit (line 18) and simultaneously at an entrance to stand 1 (line 19). During and after the event, additional lines may be added and/or commented. A second illustrative example in line 20 shows a comment “SUSPECT EXIT DETECTED 350.0”. This comment shows that an activator did not originally report an exit in line 20, but was a suspected exit which occurred between 325 (minutes) and 350 (minutes).

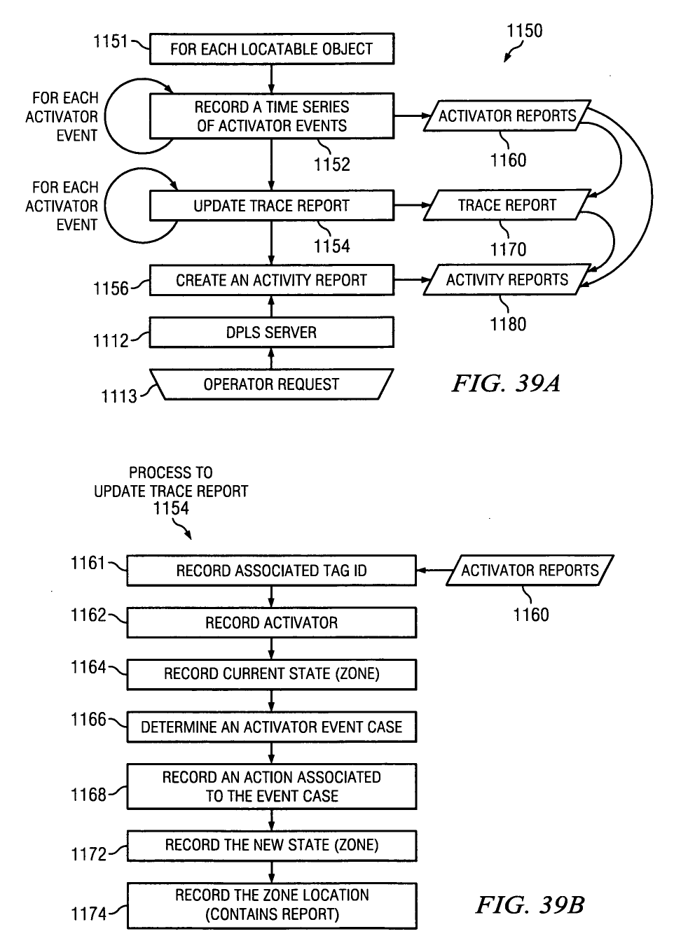

FIGS. 39A and 39B are a flowchart of a method to determine and report the activity of a locatable object. The DPLS server 1112 (see also FIG. 33A) is used to implement the method 1150 of FIG. 39A which performs steps 1152 and 1154 whenever a new locatable object is detected by an activator and performs step 1156 on request by the DPLS server 1112. Preferably, steps 1152, 1154 and 1156 are fully autonomous database update mechanisms and are continuously performed in the DPLS system to keep locatable object tags associated to the zones in which they are located in near real-time. Alternatively, the step 1156 may be performed manually via an operator request 1113 of the DPLS system.

For each activator event, step 1152 records a time series of activator events associated to the locatable object and stores them as an activator report in the set of activator reports 1160. FIG. 36 provides an example of an activator report and indicates the fields stored therein.

For each activator event, step 1154 then updates a trace report in the set of trace reports 1170 to reflect known and calculable changes to the state of the locatable object using one or more of the activator reports in the set of activator reports 1160. FIG. 37 provides an example of a trace report and indicates the fields recorded therein as updates, where each update generates a new row. Preferably, step 1154 is completely autonomous and proceeds in real-time whenever a new tag is reported by an activator event. Alternatively, step 1154 may be run by DPLS server 1112 on a scheduled basis, for example, once per minute per tag ID.

Step 1156 creates an activity report and stores it in the set of activity reports 1180 that show locatable objects entry and exit activities for each zone as a function of time. FIG. 38 provides an example of an activity report and indicates the fields generated for each entry and exit activity. Activity reports are generated by joining associated reports in the set of activator reports 1160 and the set of trace reports 1170.

FIG. 39B is a flowchart of a sub process to update the trace report as in step 1154. Refer also to FIG. 37. The trace report is updated by adding lines, one for each new activator event in activator reports 1160, each activator event associated to a tag ID. In step 1161, the associated tag ID is recorded in tag ID field 1193. In step 1162, the activator location is recorded in reported location field 1194. In step 1164, the current zone field 1195 is updated with the previous event's new zone field. In step 1166, a change of state case is evaluated and recorded in case field 1196. In step 1168, an action associated to the change of state case is recorded in actions field 1197. In step 1172, new zone field 1198 is updated with the new zone containing the reporting activator and in step 1174, a list of zones is generated, starting from the outermost containing zone and encapsulating all the zones which contain the reporting activator, the list of zones being stored in the zone list field 1199.

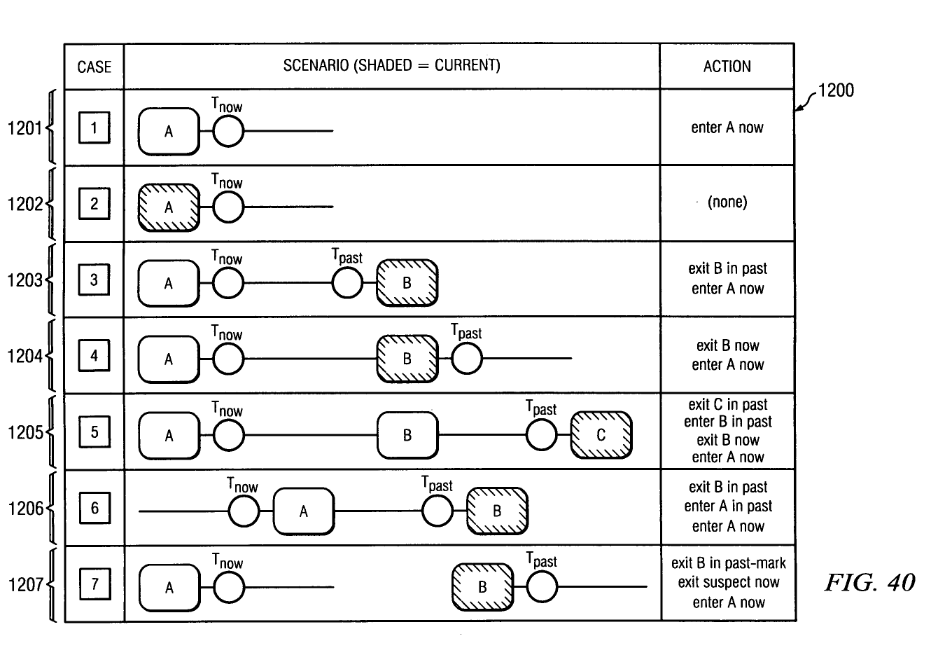

Steps 1166 and 1168 may be explained more fully referring to help of FIG. 40 in which a set of cases 1200 are shown in tabular form, each case described in a row of the table comprising a case number, a scenario and an action. The scenarios are possible state diagrams using the same notation as described previously in connection with FIG. 34, the most important aspects being that a shaded zone is representative of a currently occupied zone (occupied), a white zone is representative of an unoccupied zone (unoccupied), a shaded circle is representative of a activator currently detecting the presence of a tag (active now), a black circle is representative a previously detected activator (prior active) and the solid lines are allowed passageways between zones. In the description that follows, case N, scenario N and action N refer to rows 1201, 1202 . . . 1207 which correspond to N=1, 2 . . . 7. Whenever an activator report occurs for a tag, each row is checked in order, from N=1 to 7, to figure out which case applies to the report in context with the last report for the same tag. The action describes what state change the system is to make for the same tag.

Case 1 is shown in row 1201. Scenario 1 is a state wherein an activator contained in zone A is active now, but there is no prior active state or occupied state. This scenario indicates that a tag has just entered a zone for the first time from an unknown state and location, perhaps through an outside entryway. According to Action 1 then, the tag has “entered A now”.

Case 2 is shown in row 1202. Scenario 2 is a state wherein an activator contained in zone A is active now and zone A is occupied. This scenario indicates a tag being in a zone and staying within that zone, so the Action 2 is “none”.

Case 3 is shown in row 1203. Scenario 3 is a state wherein zone A is unoccupied and zone B is occupied. Furthermore, Scenario 3 indicates that an activator in zone B and on the path between zone A and zone B was prior active and that the activator in zone A is active now. This scenario indicates the movement of a tag from zone B to zone A with an established exit time from B. According to Action 3 then, the tag has moved to “exit B in past” and “enter A now”.

Case 4 is shown in row 1204. Scenario 4 is a state wherein zone A is unoccupied and zone B is occupied. Furthermore, Scenario 4 indicates that an activator in zone A is active now and that an activator in zone B was prior active, however, the prior active activator is not on the path between zone A and zone B. This scenario indicates the movement of a tag from zone B to zone A, but the exit time from B is not established. According to Action 4 then, the tag movement is described by “exit B now” and “enter A now”.

Case 5 is shown in row 1205. Scenario 5 is a state wherein zone A is unoccupied, zone B is unoccupied and zone C is occupied. Scenario 5 further indicates that an activator in zone A is active now and that another activator in zone C and on the path between zone B and zone C was prior active. This scenario indicates the movement of a tag from zone C to zone A via zone B, with a known exit time from zone C being the only a priori information. Action 5 is recorded as “exit C in past”, “enter B in the past”, “exit B now” and “enter A now”.

Case 6 is shown in row 1206. Scenario 6 is a state wherein zone A is unoccupied, zone B is occupied. Furthermore, Scenario 6 describes that an activator in zone B and on the path between zones A and B was prior active. Scenario 6 further describes that an activator contained in zone A is active now, but this zone A activator is not on the path between zones A and B. This scenario indicates that a tag left zone B at a known time in the past and traveled through zone A to a new path. However, Case 6 can only establish that the tag is currently detected in zone A. Action 6 captures the measured tag movement as “exit B in past”, “enter A in past”, “enter A now”.

Case 7 is shown in row 1207. Scenario 7 is a state wherein zone A is unoccupied but contains an activator that is active now. Furthermore zone B, which is not connected by a path to zone A, is occupied and contains an activator that was prior active. So this scenario indicates that the tag must have entered zone B at a known time in the past and somehow found its way out and over to zone A, possibly traversing a path through other zones. This scenario may also indicate that an activator missed the detection of the tag as it exited zone B on the way to another zone. Action 7 captures the unresolved nature of the tag movement as “exit B in past”, “mark exit suspect now” and “enter A now”.

As an example, case 7 is indicated in the trajectory 1106 of FIG. 35 and shown in trace report 1191 of FIG. 37. Trajectory 1106 shows that the associated tag entered stand 1 as detected by A6 and that a detection was missed at A9 while the associated tag was on route from stand 1 to the building zone. Stand 1 is not connected to the kitchen where the next tag detection occurred. Line 14 of trace report 1191 shows the DPLS system identified the previously described state as case 7 and recorded the actions according to action 7 as “exit Stand 1 in past and mark suspect, enter Kitchen now”. The suspected exit of stand 1 may be resolved with the help of Line 15 which describes the new state wherein the tag is detected at A12. Since A12 is on a path connecting the hall to the building to the kitchen (cf. case 5), the tag movement may be resolved in the activity report as an exit of stand 1 at the time of the A6 stand 1 detection and an entry into the building at the time of the kitchen detection.

In the previous example, there is the potential for error in the reported exit time of stand 1, so the activity report indicates the suspect bracket time. Line 20 of activity report 1181 in FIG. 38 shows “SUSPECT EXIT DETECTED 350.0” which means that the exit time is bracketed between the 325 minutes shown for the stand 1 exit time and the 350 minutes shown for the kitchen entry time in line 21.

The DPLS system may report an estimated exit time for a case 7 scenario as one of: a bracket of time between two times, a time computed from an average speed of movement of a tag, and an interpolation from a list of times.

Much of the value of this invention can also be delivered in a permanent installation setting such as a museum. In that case, the content is less marketing and advertising oriented and more centered on interactively delivering specific content concerning individual museum exhibitions.

It will be appreciated by those skilled in the art that changes could be made to the exemplary embodiments described above without departing from the broad inventive concept thereof. It is understood, therefore, that this invention is not limited to the particular embodiments disclosed, but it is intended to cover modifications within the spirit and scope as defined by the appended claims.

1. A method of gathering event data for an event and managing the event according to an event design, the event data describing behaviors of a set of organizers, a set of attendees and a set of exhibitors in an event facility during the event, the method including the steps of:
analyzing the event to establish goals of reciprocity between the set of attendees, the set of exhibitors and the set of organizers;
formulating a data collection strategy to gather the event data to meet the established goals of reciprocity for the event;
formulating a data generation plan to carry out the data collection strategy for the event, the formulation of the data generation plan including the substeps of:
defining a real-time information marketing system (RTIMS) to be used for data collection at the event facility;
choosing a set of locating systems for deployment at the event facility, the set of locating components further selected from the group of a real time location system (RTLS), a set of passive RFID locating systems, and a set of active RFID locating systems;
choosing a set of locatable tag devices for deployment on the set of participants, the set of locatable tag devices selected from the group of RTLS tag devices, passive RFID tag devices, active RFID tag devices, barcode readers, magnetic strip readers; and,
choosing a set of controllable components for deployment at the event facility, the set of controllable components selected from the group of interactive kiosks, digital signage, and a set of controllable devices capable to create ambient intelligence.
classifying a group of location metric types;
assigning a location metric type to each of the chosen set of location systems from the group of location metric types;
quantifying a measure of location information incorporated in the data generation plan;
writing a set of detailed specifications and requirements for the data generation plan; and,
implementing the data generation plan at the event.

2. The method of claim 1 in which the step of classifying the group of location metric types includes classifying a position location metric type as being capable of measuring a set of coordinates of a locatable tag device to an accuracy better than 15 cm, the set of coordinates being measured relative to a predefined origin in the event facility.

3. The method of claim 1 in which the step of classifying the group of location metric types includes classifying a proximity location metric type as being capable of determining that a locatable tag device is within about 5 cm of a measurement point.

4. The method of claim 1 in which the step of classifying the group of location metric types includes classifying a vicinity location metric type as being capable of determining that a locatable tag device is within about 2.5 m of a measurement point.

5. The method of claim 1 in which the step of classifying the group of location metric types includes classifying an area location metric type as being capable of determining that a locatable tag device is within about 7.5 m of a measurement point.

6. The method of claim 1 in which the step of classifying the group of location metric types includes classifying a space location metric type as being capable of determining that a locatable tag device has either entered or exited the event facility.

7. The method of claim 1 where the step of quantifying a measure of location information incorporated in the data generation plan includes calculating a location awareness factor having a range of values from 0% to 100%.

8. The method of claim 1 where the step of analyzing the event to establish goals of reciprocity includes the substeps of
interviewing participants chosen from the group of attendees, exhibitors and organizers of the event;
determining information required to obtain a positive return on investment for the participants of the event; and,
determining a set of value types exchanged between the participants.

9. The method of claim 1 wherein the step of formulating the data collection strategy includes the further step of designing equipment and software functionality to execute value exchanges between participants chosen from the group of attendees, exhibitors and organizers of the event.

10. A system for reporting event data in the form of merged office documents for event clients associated to an event, the system including a computer network having computer servers with memory and data storage devices and capable of networked operations by a report analyst and a report designer, the system comprising:
a first computer terminal associated to the report analyst and communatively connected to the computer network;
a second computer terminal associated to the report designer and communatively connected to the computer network;
a viewer application program operating on a the first computer terminal and capable of extracting tabular data from the event data under the operational instructions of the event analyst, and further capable to store the operational instructions as a set of asset definition macros in the computer network;
an office productivity program operating on the second computer terminal and capable to derive and store a document template for a document that contains parameterized elements; and,
a document manipulation means resident on the computer network for changing the parameterized elements of the document template according to a set of data contained in the extracted tabular data and for saving the document template with changed elements as merged office document.

11. The system of claim 10 in which the document templates are stored in XML format.

12. The system of claim 10 in which the document that contains parameterized elements may be selected from the group of a spreadsheet file, a slide presentation file, a file containing text, a file containing graphical drawings, a file containing a mixture of text and graphical drawings, a database file.

13. A method for reporting event information gathered from a set of events into a set of report documents customized for event clients that are associated to the set of events, the method being implemented on a reporting system comprising a computer network with a set of computer servers having memory and data storage devices and capable to allow networked operations, a first computer terminal communatively connected to the computer network, a second computer terminal communatively connected to the computer network and a set of client computers communicatively connected to the computer network, the method including the steps of:
creating a first office document using an office productivity program operating on the first computer terminal;
parameterizing elements of the first office document to create a document template;
saving the document template in the computer network;
operating a viewer application program on the second computer terminal;
extracting a first set of event data from the event information;
recording an asset definition describing the extraction of the first set of event data and capable to replay the extraction;
automatically applying the asset definition to the event information to extract a second set of event data;
storing the second set of extracted data in the computer network;
manipulating the parameterized elements of the document template into a report document according to data contained in the second set of extracted data;
storing the report document in the computer network; and,
sending the report document to the an event client associated to an event in the set of events.

14. The method of claim 13 in which the step of saving the document templates includes saving the document template in XML format.

15. The method of claim 13 in which the step of creating a first office document includes a step of selecting a document type for the first office document from the group of a spreadsheet file, a slide presentation file, a file containing text, a file containing graphical drawings, a file containing a mixture of text and graphical drawings and a database file.

16. A directional portal locating system (DPLS) used in conjunction with meetings, incentives, conferences and exhibitions (MICE) events to produce a set of activity reports of participants at MICE events, wherein each activity report in the set of activity reports indicate entry and exit of participants into predefined zones at measured times within MICE event facilities, the DPLS comprising:
a computer network;
a DPLS server connected to the computer network;
a set of locatable tags associated one-for-one to participants of the MICE event, each locatable tag in the set of locatable tags having a unique tag identifier;
a set of activators connected to the computer network and communicatively connected to the DPLS server, wherein each activator is associated to one of the predefined zones and capable to detect and to report proximity of locatable tags to the DPLS server and wherein each activator has a predefined unique activator identifier;
the DPLS server further programmed to store reported proximity detections in a set of activity reports;
the DPLS server programmed to create a set of trace reports from the activity report, wherein the set of trace reports include at least the unique tag identifier associated to each reported proximity detection and a movement action associated to each proximity detection; and,
the DPLS server further programmed to create the set of activity reports from the set of trace reports.

17. The system of claim 16 in which the set of activator reports include for each reported proximity detection by a reporting activator in the set of activators at least: a time of proximity detection, the unique activator identifier of the reporting activator, the unique tag identifier associated to a detected locatable tag and a predefined zone associated to the reporting activator.

18. The system of claim 16 in wherein the set of trace reports further include a reported zone associated to each reported proximity detection and a current zone describing the current location of the locatable tag associated to each reported proximity detection.

19. The system of claim 18 wherein the set of trace reports further include a zone list describing the nesting of predefined zones for the locatable tag associated to each reported proximity detection.

20. A method for locating participants of meetings, incentives, conferences and exhibitions (MICE) events in MICE facilities utilizing a directional portal locating system (DPLS) comprising a computer network, a DPLS server connected to the computer network, a set of locatable tags associated one-for-one to participants of the MICE event, each locatable tag in the set of locatable tags having a unique tag identifier, a set of activators connected to the computer network and communicatively connected to the DPLS server, wherein each activator is capable to detect and to report proximity of locatable tags to the DPLS server and wherein each activator has a predefined unique activator identifier, the method including the steps of:
assigning an activator location to each activator in the set of activators, the activator location being assigned as one of a set of predefined zones in the MICE facilities;
recording a time series of activator proximity detections into a set of activator reports, one activator report associated to each activator proximity detection;
recording a reported unique activator identifier in each activator report;
updating a set of trace reports, one trace report associated to each activator proximity detection; and,
creating a set of activity reports, one activity report for each activator proximity detection wherein the activity report is constructed from the activator report and the trace report.

21. The method of claim 20 wherein the step of updating the set of trace reports includes the following steps:
recording a reported unique tag identifier in each trace report;
recording a current tag location in each trace report, the current tag location recorded as the latest recorded tag location of the reported unique tag identifier as found in a previous trace report;
determining a scenario associated to each trace report;
recording a movement action for the case type in each trace report; and,
recording a new tag location in each trace report, the new tag location recorded as the activator location of each associated activator proximity report.

22. The method of claim 21 including the additional step of recording a zone list describing the nesting of predefined zones for a reported locatable tag associated to the reported unique tag identifier.

23. The method of claim 21 where the step of determining a scenario associated to each activator report includes the steps of:
identifying a set of scenarios, each scenario assigned a unique index where each scenario describes a state of the directional portal system for a single locatable tag in the set of locatable tags, each scenario further associated to a movement action;
determining a current activator location of the activator associated to each activator report;
determining a current detection time of the activator proximity detection associated to the activator report;
determining a previous activator location of the activator associated to each activator report;
determining a previous detection time of a previous activator proximity detection of the activator associated to each activator report;
matching a scenario to the current activator location, the current detection time, the previous activator location, and the previous detection time wherein each scenario in the set of scenarios are checked for a match in order of their assigned unique index; and,
assigning a scenario based on the result of the matching step.

24. The method of claim 23 wherein the step of identify a set of scenarios includes the steps:
identifying a first scenario as an active state wherein a first activator contained in a first zone is active now, but there is no previously active state;
identifying a second scenario as an active state wherein a first activator contained in the first zone is active now and the first zone is occupied;
identifying a third scenario as an active state wherein the first zone is unoccupied, a second zone is occupied, a second activator in the second zone and on a physical path between the first and second zones was previously active, and the first activator in first zone is active now;
identifying a fourth scenario as an active state wherein the first zone is unoccupied, a second zone is occupied, the first activator in the first zone is active now, a third activator in the second zone was previously active, and the third activator is not on the path between the first zone and the second zone;
identifying a fifth scenario as an active state wherein the first zone is unoccupied, the second zone is unoccupied, a third zone is occupied, the first activator in the first zone is active now, and a fourth activator in the third zone and on the path between the second and third zones was previously active;
identifying a sixth scenario as an active state wherein the first zone is unoccupied, the second zone is occupied, the third activator in the second zone and on the physical path between the first and second zones A and B was previously active, a fifth activator contained in the first zone is active now, the fifth activator is not on the path between the first and second; and,
identifying a seventh scenario as an active state wherein the first zone is unoccupied, the first zone contains the first activator that is active now, the second zone is not connected by a path to the first zone, the second zone is occupied, and the second zone contains the third activator that was previously active.

25. The method of claim 24 including the additional step of indexing the first scenario with an index of 1 (one), the second scenario with an index of 2 (two), the third scenario with an index of 3 (three), the fourth scenario with an index of 4 (four), the fifth scenario with an index of 5 (five), the sixth scenario with an index of 6 (six), and the seventh scenario with an index of 7 (seven).

26. The method of claim 24 including the additional steps of:
associating a first movement action with the first scenario of entering the first zone now;
associating a second movement action with the second scenario of no movement;
associating a third movement action with the third scenario of exiting the second zone in the past and entering the first zone now;
associating a fourth movement action with the fourth scenario of exiting the second zone now and entering the first zone now;
associating a fifth movement action with the fifth scenario of exiting the third zone in the past, entering the second zone in the past, exiting the second zone now, and entering the first zone now;
associating a sixth movement action with the sixth scenario of exiting the second zone in the past, entering the first zone in the past, and entering the first zone now; and,
associating a seventh movement action with the seventh scenario of exiting the second zone in the past, marking the second zone exit as suspect now, and entering the first zone now.
